(19) United States
(12) Patent Application Publication
(10) Pub. No.: US 2026/0089299 A1
(43) Pub. Date: Mar. 26, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Cheulhee HAHM, Suwon-si (KR); Prabhat AWASTHI, Suwon-si (KR); Hyungrae KIM, Suwon-si (KR)

(73) Assignee: SAMSUNG ELECTRONICS CO., LTD., Suwon-si (KR)

(21) Appl. No.: 19/338,749

(22) Filed: Sep. 24, 2025

Related U.S. Application Data
(63) Continuation of application No. PCT/KR2025/010189, filed on Jul. 11, 2025.

(30) Foreign Application Priority Data
Sep. 26, 2024 (KR) 10-2024-0130735
Feb. 20, 2025 (KR) 10-2025-0022319

(51) Int. Cl. H04N 9/31; G06F 3/042

(52) U.S. Cl. CPC H04N 9/3194; G06F 3/0421; H04N 9/3185; H04N 9/3188

(57) ABSTRACT

According to an embodiment of the disclosure, an electronic apparatus includes a projection part to project images on a projection surface, at least one sensor to obtain data corresponding to the projection surface, memory storing at least one instruction, and at least one processor. The data obtained by the sensor includes infrared data obtained through infrared radiation (IR) reflected from the projection surface and data not obtained from IR reflection. The at least one processor is configured to execute instructions in memory to control the projection part to project a test image, obtain a first area based on data not obtained by IR reflection obtained by the at least one sensor while the test image is projected, obtain a second area based on infrared data, and obtain a projection area based on the first area and the second area.

### CROSS-REFERENCE TO RELATED APPLICATIONS

This application is a continuation of International Application No. PCT/KR2025/010189 designating the United States, filed on Jul. 11, 2025, in the Korean Intellectual Property Receiving Office and claiming priority to Korean Patent Application No. 10-2024-0130735, filed on Sep. 26, 2024, and Korean Patent Application No. 10-2025-0022319, filed on Feb. 20, 2025, in the Korean Intellectual Property Office, in the Korean Intellectual Property Office, the disclosures of each of which are incorporated by reference herein in their entireties.

### BACKGROUND

### Field

The disclosure relates to an electronic apparatus and a controlling method thereof, and more particularly to an electronic apparatus that obtains a projection area for projecting an image based on sensing data obtained by sensing the projection surface and a controlling method thereof.

### Description of Related Art

With recent developments electronic technology and optical technology, various projectors are being utilized. A projector may mean an electronic apparatus which projects light onto a projection surface, and forms an image on the projection.

In particular, recently, a projector that provides a touch input function by sensing movement or touch of a finger or the like of a user on the projection surface on which an image is projected is being developed. In this case, the projector may sense a touch or the like of a finger or an object through an infrared sensor.

### SUMMARY

According to an embodiment of the disclosure, an electronic apparatus includes a projection part configured to project images on a projection surface, at least one sensor configured to obtain data corresponding to the projection surface, the obtained data including infrared data obtained from infrared radiation (IR) reflected from the projection surface and data not obtained from IR reflection, a memory configured to store at least one instruction, at least one processor configured to execute the at least one instruction in memory to control the projection part to project a test image on the projection surface, obtain, based on data not obtained from IR reflection included in data corresponding to the projection surface obtained by the at least one sensor while the test image is projected on the projection surface, a first area on the projection surface, obtain, based on infrared data included in data corresponding to the projection surface obtained by the at least one sensor, a second area on the projection surface, the second area corresponding to an area of the projection surface on which an image is projectable by the projection part, and obtain a projection area on the projection surface based on the first area and the second area.

The first area may be smaller in size than an area on the projection surface on which the test image is projected and which is fully covered by the projection of the test image.

The at least one processor may be configured to execute the at least one instruction in memory to obtain an intersection image based on a plurality of images obtained from data corresponding to the projection surface, reduce the test image to a reduced test image based on at least one intersection pixel in the obtained intersection image, control the projection part to project the reduced test image on an area of the projection surface based on at least one intersection pixel in the obtained intersection image, and obtain as the first area, the area on the projection surface on which the reduced test image is projected.

The at least one processor may be configured to execute the at least one instruction to obtain a first image from data corresponding to the projection surface obtained by the at least one sensor, the first image including pixel data, obtain the intersection image based on a second image, the second image obtained based on the first image and the pixel data included in the first image, reduce the test image to the reduced test image based on a pre-set first unit and a number corresponding to the at least one intersection pixel being greater than or equal to a first threshold number, the at least one intersection pixel having a pixel value greater than or equal to a first threshold value, control the projection part to project the reduced test image on an area of the projection surface based on the at least one intersection pixel, update the number corresponding to the at least one intersection pixel based on the reduced test image, and obtain as the first area, the area on the projection surface on which the reduced test image is projected based on the updated number corresponding to the at least one intersection pixel being less than the first threshold number.

The at least one processor may be configured to execute the at least one instruction in memory to identify at least one valid pixel in an infrared image obtained from infrared data corresponding to the area on which the test image is projected, the at least one valid pixel having a pixel value greater than or equal to a second threshold value, and obtain the second area on the projection surface based on the identified at least one valid pixel.

The at least one processor may be configured to execute the at least one instruction in memory to reduce the test image to a reduced test image based on a pre-set second unit and a number corresponding to the at least one valid pixel being greater than or equal to a second threshold number, control the projection part to project the reduced test image on an area of the projection surface based on the at least one valid pixel, update the number corresponding to the at least one valid pixel based on the reduced test image, and obtain as the second area, the area on the projection surface on which the reduced test image is projected based on the updated number corresponding to the at least one valid pixel being less than the second threshold number.

The test image may be a primary test image, and the at least one processor may be configured to execute the at least one instruction in memory to, before projecting the primary test image, control the projection part to project an initial test image including an infrared pattern, control the projection part to project the primary test image including an RGB pattern based on a function associated with a correction based on the infrared pattern not being performed, and obtain the second area based on the infrared data included in data corresponding to the projection surface obtained while the initial test image is projected.

The at least one processor may be configured to execute the at least one instruction in memory to, based on an area of a small size included in the first area and included in the second area being greater than or equal to a defined threshold size, obtain the area of a small size as the projection area.

The electronic apparatus may further include a movement part, and the at least one processor may be configured to execute the at least one instruction in memory to control the movement part to move the electronic apparatus from a current position corresponding to a projection of the test image to a second position corresponding to an image projection at the projection area.

The at least one processor may be configured to execute the at least one instruction in memory to identify, using an artificial intelligence model, at least one obstacle based on data corresponding to the projection surface, obtain a third area included in an area on the projection surface which excludes an area on the projection surface corresponding to the obstacle, and obtain the projection area based on the first area, the second area, and the third area.

According to an embodiment of the disclosure, a method for controlling an electronic apparatus that includes a projection part configured to project images on a projection surface, and at least one sensor configured to obtain data corresponding to the projection surface, the obtained data including infrared data obtained from infrared radiation (IR) reflected from the projection surface and data not obtained from IR reflection, the method includes controlling the projection part to project a test image on the projection surface obtaining, based on data not obtained from IR reflection included in data corresponding to the projection surface obtained by the at least one sensor while the test image is projected on the projection surface, a first area on the projection surface obtaining, based on infrared data included in data corresponding to the projection surface obtained by the at least one sensor, a second area on the projection surface, the second area corresponding to an area on the projection surface on which an image is projectable by the projection part, and obtaining a projection area on the projection surface based on the first area and the second area.

The obtaining, based on data not obtained from IR reflection included in data corresponding to the projection surface obtained by the at least one sensor while the test image is projected on the projection surface, a first area on the projection surface may include obtaining the first area smaller in size than an area on the projection surface on which the test image is projected and which is fully covered by the test image.

The obtaining the first area smaller in size than an area on the projection surface on which the test image is projected and which is fully covered by the test image may include obtaining an intersection image based on a plurality of images obtained from data corresponding to the projection surface, reducing the test image to a reduced test image based on at least one intersection pixel in the obtained intersection image, controlling the projection part to project the reduced test image on an area of the projection surface based on at least one intersection pixel in the obtained intersection image, and obtaining as the first area, the area on the projection surface on which the reduced test image is projected.

The obtaining an intersection image based on a plurality of images obtained from data corresponding to the projection surface may include obtaining a first image from data corresponding to the projection surface obtained by the at least one sensor, the first image including pixel data, and obtaining the intersection image based on a second image, the second image obtained based on the first image and the pixel data included in the first image. The reducing the test image to a reduced test image based on at least one intersection pixel in the obtained intersection image may include reducing the test image to a reduced test image based on a pre-set first unit and a number corresponding to the at least one intersection pixel being greater than or equal to a first threshold number, the at least one intersection pixel having a pixel value greater than or equal to a first threshold value. The obtaining as the first area, the area on the projection surface on which the reduced test image is projected may include updating the number corresponding to the at least one intersection pixel based on the reduced test image, and obtaining, as the first area, the area on the projection surface on which the reduced test image is projected based on the updated number corresponding to the at least one intersection pixel being less than the first threshold number.

The obtaining a second area may include identifying at least one valid pixel in which a pixel value in an infrared image obtained from the infrared data corresponding to the area on which the test image is projected is greater than or equal to a second threshold value, and obtaining the second area based on the identified at least one valid pixel from among the projection surface.

The obtaining the second area based on the identified at least one valid pixel from among the projection surface may include reducing and projecting the test image to a pre-set second unit based on a number of the at least one valid pixel being greater than or equal to a second threshold number, updating the number of the at least one valid pixel based on the reduced test image, and obtaining an area on which the reduced test image is projected as the second area based on the updated number of the at least one valid pixel being less than the second threshold number.

The projecting a test image may include projecting an initial test image including an infrared pattern, and projecting the test image including an RGB pattern based on a function associated with a correction based on the infrared pattern not being performed, and the obtaining the second area may include obtaining the second area based on the infrared data from among data corresponding to a projection surface obtained through the projection surface on which the initial test image is projected.

The obtaining a final area based on the first area and the second area may include obtaining, based on an area of a small size from among the first area and the second area being greater than or equal to a defined threshold size, the area of a small size as the projection area.

The controlling method may further include controlling a movement part of the electronic apparatus to move from a current position corresponding to a projection of the test image to a second position corresponding to an image projection at the projection area.

According to an embodiment of the disclosure, a non-transitory computer-readable storage medium which stores computer instructions for an electronic apparatus including a projection part configured to project images on a projection surface, and at least one sensor configured to obtain data corresponding to the projection surface, the obtained data including infrared data obtained from infrared radiation (IR) reflected from the projection surface and data not obtained from IR reflection, the operation including controlling the projection part to project a test image on the projection surface, obtaining, based on data not obtained from IR reflection included in data corresponding to the projection surface obtained by the at least one sensor while the test image is projected on the projection surface, a first area on the projection surface, obtaining, based on infrared data included in data corresponding to the projection surface obtained by the at least one sensor, a second area on the projection surface, the second area corresponding to an area of the projection surface on which an image is projectable by the projection part, and obtaining a projection area on the projection surface based on the first area and the second area.

### BRIEF DESCRIPTION OF THE DRAWINGS

FIG. 1 is a diagram illustrating schematically an operation of an electronic apparatus according to one or more embodiments of the disclosure;

FIG. 2 is a block diagram illustrating a configuration of an electronic apparatus according to one or more embodiments of the disclosure;

FIG. 3 is a detailed block diagram illustrating a detailed configuration of an electronic apparatus according to one or more embodiments of the disclosure;

FIG. 4 is a diagram illustrating an operation of an electronic apparatus according to one or more embodiments of the disclosure;

FIG. 5 is a diagram illustrating a movement of an electronic apparatus according to one or more embodiments of the disclosure;

FIG. 6 is a diagram illustrating a maximum reduced scale according to one or more embodiments of the disclosure;

FIG. 7 is a diagram illustrating an obstacle detector according to one or more embodiments of the disclosure;

FIG. 8 is a flowchart illustrating a controlling method of an electronic apparatus according to one or more embodiments of the disclosure;

FIG. 9 is a flowchart illustrating an operation of an electronic apparatus using a surface size detector and an infrared emission detector according to one or more embodiments of the disclosure; and

FIG. 10 is a diagram illustrating an operation of an electronic apparatus using an obstacle detector according to one or more embodiments of the disclosure.

### BRIEF DESCRIPTION OF THE DRAWINGS

Various modifications may be made to the embodiments of the disclosure, and there may be various types of embodiments. Accordingly, specific embodiments will be illustrated in drawings, and described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. With respect to the description of the drawings, like reference numerals may be used to indicate like elements.

In describing the disclosure, in case it is determined that the detailed description of related known technologies or configurations may unnecessarily confuse the gist of the disclosure, the detailed description thereof will be omitted.

Further, the embodiments below may be modified to various different forms, and it is to be understood that the scope of the technical spirit of the disclosure is not limited to the embodiments below. Rather, the embodiments are provided so that the disclosure will be thorough and complete, and to fully convey the technical spirit of the disclosure to those skilled in the art.

Terms used in the disclosure have been merely used to describe a specific embodiment, and is not intended to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) at least one A, (2) at least one B, or (3) both of at least one A and at least one B.

Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

Conversely, when a certain element (e.g., first element) is indicated as “directly coupled with/to” or “directly connected to” another element (e.g., second element), it may be understood as the other element (e.g., third element) not being present between the certain element and the another element.

The expression “configured to . . . (or set up to)” used in the disclosure may be used interchangeably with, for example, “suitable for . . . ”, “having the capacity to . . . ”, “designed to . . . ”, “adapted to . . . ”, “made to . . . ”, or “capable of . . . ” based on circumstance. The term “configured to . . . (or set up to)” may not necessarily mean “specifically designed to” in terms of hardware.

Rather, in a certain circumstance, the expression “a device configured to . . . ” may mean something that the device “may perform . . . ” together with another device or components. For example, a phrase “processor configured to (or set up to) perform A, B, or C” may mean a dedicated processor for performing a relevant operation (e.g., an embedded processor), or a generic-purpose processor (e.g., a central processing unit (CPU) or an application processor) capable of performing the relevant operations by executing one or more software programs stored in a memory device.

The term ‘module’ or ‘part’ used in the embodiments herein perform at least one function or operation, and may be implemented with a hardware or software, or implemented with a combination of hardware and software. In addition, a plurality of ‘modules’ or a plurality of ‘parts’, except for a ‘module’ or a ‘part’ which needs to be implemented with a specific hardware, may be integrated in at least one module and implemented as at least one processor.

Meanwhile, the various elements and areas of the drawings have been schematically illustrated. Accordingly, the technical spirit of the disclosure is not limited by relative sizes and distances illustrated in the accompanied drawings.

Embodiments of the disclosure will be described in detail below with reference to the accompanying drawings to aid in the understanding of those of ordinary skill in the art.

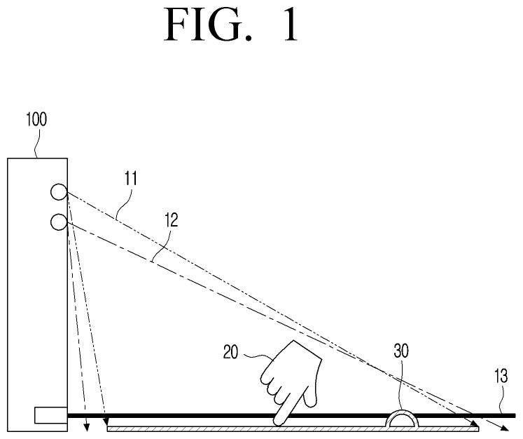

FIG. 1 is a diagram illustrating schematically operations of an electronic apparatus and an external electronic apparatus according to one or more embodiments of the disclosure.

Referring to FIG. 1, an electronic apparatus 100 is described.

The electronic apparatus 100 may be implemented as at least one from among a smartphone, a tablet personal computer (PC), a desktop PC, a laptop PC, a PC, a set top box, an over-the-top media service (OTT service) server, a video game console, a Blu Ray Player, a Digital Video Disc or Digital Versatile Disc (DVD) player, a home automation control panel, a security control panel, a media box (e.g., a SAMSUNG HomeSync™, APPLE TV™, or a GOOGLE TV™), and a game console (e.g., a Xbox™, a PlayStation™). However, the embodiment is not limited thereto.

For example, the electronic apparatus 100 may correspond to a projector which can project an image. Here, the projector may mean a device which can project an image to a wall or a screen. The electronic apparatus 100 may project an image from a suitable position by moving around a surrounding space.

Here, the surrounding space may mean a space including a movable path and a wall or other objects for projecting an image. For example, the surrounding space may be implemented as a space inside a home, an office, a storage, and the like.

Meanwhile, the electronic apparatus 100 may sense the surrounding space. For example, the electronic apparatus 100 may sense the surrounding space to determine a suitable projection surface for projecting an image from among the surrounding space. Here, the electronic apparatus 100 may use sensing data obtained by sensing the surrounding space. Here, the sensing data will be described in detail in the following description.

Here, the electronic apparatus 100 sensing the surrounding space may mean obtaining an image on the surrounding space. For example, the electronic apparatus 100 may obtain an image by capturing the surrounding space based on a user operation input for capturing the surrounding space.

Here, the captured surrounding space may correspond to a projection surface (e.g., a wall, a floor, a ceiling, etc.) on which an image is projected. Here, the projected image may correspond to an image projected by the electronic apparatus 100. However, the embodiment is not limited thereto, and may correspond to an image projected by an external device.

Meanwhile, the projected image may correspond to a test image for correcting a projection area. Here, the correction may mean a keystone correction. Here, the keystone correction may mean a function for forcibly moving a corner portion of a screen being projected. That is, the keystone correction may mean a function for adjusting a screen being shown to be close to an original form of a quadrangle.

For example, the electronic apparatus 100 may perform the keystone correction through the test image. Here, the projection area on which the test image is projected may be captured using a camera provided in the electronic apparatus 100, and the keystone correction may be performed based on the captured image.

However, the embodiment is not limited thereto, and the electronic apparatus 100 may use the test image for performing other corrections.

For example, the electronic apparatus 100 may use the test image for identifying a touch position of a user. The electronic apparatus 100 may sense a distortion or a boundary of a projected pattern by projecting the test image. The electronic apparatus 100 may adjust a size and position of a screen by analyzing a result obtained by sensing.

The electronic apparatus 100 may identify, after the projection area is adjusted, a touch position from a position at which a touch event has occurred based on the adjusted projection area. In this case, the electronic apparatus 100 may identify the touch position using infrared radiation 13.

Here, the infrared radiation 13 may correspond to light emitted by the electronic apparatus 100. The infrared radiation 13 may be reflected by a finger 20 of the user after being emitted by the electronic apparatus 100. The electronic apparatus 100 may receive the reflected light through the camera.

Here, the camera may receive light through an image sensor (e.g., an infrared sensor). The camera may be provided in the electronic apparatus 100, but is not necessarily limited thereto, and may be provided in an external device. If the camera is provided in the electronic apparatus 100, the camera may sense a space according to a sensing range 11. That is, the camera may sense light reflected by the space within the sensing range 11.

Here, the sensing range 11 may be determined based on a projection range 12. Here, the projection range 12 may be determined by a projection area (or an adjusted projection area). For example, the sensing range 11 may be determined as a range for sensing the projection area. Here, the projection area may mean an area for projecting an image by the electronic apparatus 100 and receiving input of a touch.

The electronic apparatus 100 may identify a touch position by mapping a sensed positon of reflected light and adjustment data of the projection area. Here, the adjustment data may mean data obtained by analyzing a boundary, distortion, and the like of the projected test image. For example, the adjustment data may include a screen size and position information generated after the projection area is adjusted.

Meanwhile, the electronic apparatus 100 may sense, based on an obstacle 30 being present on the projection surface, the infrared radiation reflected by the obstacle 30. In this case, the electronic apparatus 100 may map the position of the reflected infrared radiation and adjustment data of the projection area and recognize as a touch being input.

In this case, the electronic apparatus 100 may recognize as a touch being input at a position of the obstacle 30. The electronic apparatus 100 may wrongly recognize as a touch being input at the position of the obstacle 30 even when a touch by the finger 20 of the user is actually input from a different position, or when there is no touch by the finger 20 of the user.

Accordingly, the electronic apparatus 100 may obtain a projection area excluding the area at which the obstacle 30 is positioned by adjusting (or re-adjusting) the projection area. If the electronic apparatus 100 identifies a space positioned at a left side of the obstacle 30 as the projection area, the electronic apparatus 100 may not be affected by the obstacle 30.

For example, the electronic apparatus 100 may recognize, based on there being a touch by the finger 20 of the user, as there being a touch input at only the position of the finger 20.

As described above, an operation, by the electronic apparatus 100, for adjusting the projection area based on the position of the obstacle 30 and the like will be described in detail below in the following description.

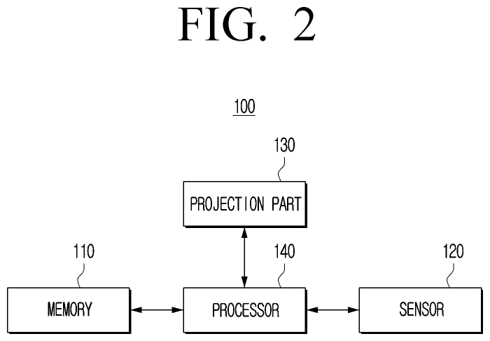

FIG. 2 is a block diagram illustrating a configuration of an electronic apparatus according to one or more embodiments of the disclosure.

Referring to FIG. 2, the electronic apparatus 100 may include a memory 110, a sensor 120, a projection part 130, and a processor 140.

Because the electronic apparatus 100 has been described above, redundant descriptions thereof will be omitted.

A memory embedded in the electronic apparatus 100 may be implemented as at least one from among a volatile memory (e.g., a dynamic random access memory (DRAM), a static RAM (SRAM), or a synchronous dynamic RAM (SDRAM)), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)). A memory attachable to or detachable from the electronic apparatus 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., a USB memory) connectable to a USB port, or the like.

The memory 120 may include one or more storage media (or one or more storage devices). For example, the memory 120 may include a memory assembly including one or more storage media. For example, the one or more storage media may include a permanent memory (e.g., non-volatile memory) such as a hard drive, a flash memory, or a read-only memory (ROM), a semi-permanent memory (e.g., volatile memory) such as a random access memory (RAM), any other suitable type of storage (or a storage assembly), or any combination thereof. The memory 110 may include a cache memory which is a memory of one or more different types used to temporarily store data for functions or features of the electronic apparatus 100. As an unlimited example, the cache memory may be included in the processor 140. The memory 110 may be fixedly embedded in the electronic apparatus 100, or incorporated onto one or more suitable types of elements (e.g., a subscriber identify module (SIM) card and/or a secure digital (SD) card) which can be inserted into the electronic apparatus 100 or removed from the electronic apparatus 100 repeatedly.

For example, the memory 110 may store one or more software applications such as an operating system (or system) software application, a firmware software application, a driver software application, a plug-in (e.g., an add-in, an add-on, and/or an applet) software application, and/or any other suitable software applications. For example, the one or more software applications may include instructions executable by the processor 140. For example, the memory 110 may store instructions callable by an application programming interface (API). For example, the memory 110 may store instructions within a library.

The term ‘memory 110’ in the disclosure may be used as a meaning including a storage part, a ROM (not shown) in the at least one processor 140, a RAM (not shown), or a memory card (not shown) mounted to the electronic apparatus 100 (e.g., a micro SD card, a memory stick).

The memory 110 according to one or more embodiments may store at least one instruction. The at least one instruction stored in the memory 110 may have the electronic apparatus 100 perform operations when executed individually or collectively by the processor 140.

For example, the at least one instruction may correspond to an instruction for the electronic apparatus 100 to obtain the projection area. Here, the projection area may correspond to an area obtained for the electronic apparatus 100 to project an image based on a plurality of areas. Here, the plurality of areas will be described in detail in the description below.

Meanwhile, the memory 110 according to one or more embodiments may store at least one artificial intelligence model.

An artificial intelligence model may be configured with a machine learning (deep learning) technology which uses an algorithm that classifies/learns on its own characteristics of input data and element technologies which simulate functions such as recognition and determination of a human brain utilizing the machine learning algorithm.

Here, the artificial intelligence model may be referred to as a training model, a neural network model, an artificial intelligence (AI) model, a deep learning model, and the like.

Examples of element technologies may include at least one from among linguistic understanding technology for recognizing language/characters of humans, visual understanding technology for recognizing objects as if from a viewpoint of a human, inference/prediction technology for logically inferring and predicting by determining information, and knowledge representation technology for processing experience information of a human as knowledge data.

The neural network model is not limited to the above-described examples, and the neural network model may be implemented as various trained models for the electronic apparatus 100 to perform an operation necessary for obtaining content corresponding to a currently uttered voice.

According to an embodiment, the at least one neural network model stored in the memory 110 may include a model trained to identify at least one obstacle included on the projection surface based on sensing data. Here, the obstacle may correspond to an object that interferes when the electronic apparatus 100 projects an image or obstructs projection.

That is, the at least one neural network model stored in the memory 110 may be trained to detect at least one obstacle present on the projection surface by using sensing data as training data.

In this case, when new sensing data obtained by sensing the projection surface is input in the at least one neural network model, the at least one neural network model may output position and size information, and the like of the obstacle. The sensing data will be described in detail in the description below.

The sensor 120 may sense the surrounding space of the electronic apparatus 100. The sensor 120 may include at least one from among an image sensor (an RGB sensor, an infrared sensor, etc.), a LiDAR sensor, an obstacle sensing sensor, and a driving sensing sensor. The sensor 120 may generate sensing data by sensing the surrounding space of the electronic apparatus 100.

The electronic apparatus 100 may include one sensor 120, but is not limited thereto, and may be implemented with a plurality of sensors 120. For convenience of description below, it may be described assuming that the sensor 120 is implemented as at least one sensor 120.

For example, the electronic apparatus 100 may sense the surrounding space of the electronic apparatus 100 through the at least one sensor 120.

Here, the surrounding space may mean the projection surface on which the test image is projected. Here, because the test image has been described above, redundant descriptions thereof will be omitted.

The electronic apparatus 100 may obtain sensing data by sensing the projection surface. Here, the sensing data may correspond to data obtained by the electronic apparatus 100 sensing the surrounding space through the at least one sensor 120.

Here, if the at least one sensor 120 is implemented as the image sensor, sensing data may correspond to data (digital data) from visual information of the surrounding environment captured through the camera. For example, the sensing data may correspond to data including pixel information (brightness and color values of each pixel) of a captured work space.

According to an example, the at least one sensor 120 may include an RGB sensor and an infrared sensor.

The RGB sensor may correspond to an optical sensor which generates color images by sensing light with three types of color channels of red (R), green (G), and blue (B). Here, the sensing data obtained through the RGB sensor may correspond to RGB data. Here, RGB data may include values of pixel units configured with red (R), green (G), and blue (B) color channels.

The infrared sensor may correspond to a sensor which senses light of infrared (IR) band beyond visible ray range and collects reflection, distance, depth information of objects. Here, sensing data obtained through the infrared sensor may correspond to infrared data. Here, the infrared data may include information such as intensity, position, and distance of reflected light sensed through the infrared (IR) sensor.

According to one embodiment, the sensing data acquired from at least one sensor 120 may include infrared (IR) data and data not obtained from IR reflection.

For example, the IR data may correspond to data obtained from IR radiation reflected from the projection surface. The data not obtained from IR reflection may correspond to RGB data.

However, the present disclosure is not limited thereto, and the sensing data acquired from the at least one sensor 120 may include only one of the IR data and the RGB data.

Meanwhile, if the at least one sensor 120 is implemented as the LiDAR sensor, sensing data may correspond to data representing distance (or 3D position) to objects based on reflection time of a laser pulse. At this time, the sensing data may correspond to point cloud data.

The sensing data is not limited to the above-described examples, and may be implemented as data of various forms when the at least one sensor 120 is implemented as sensors of various types.

The projection part 130 may project an image. The projection part 130 may project an image on the projection area using a light source such as a lamp or an LED. For example, the projection part 130 may project light corresponding to an image through a lens and/or a mirror. Accordingly, the projected light may be image-formed on the projection area.

The projection part 130 as described may project an image in an ultra-short focus method, a projection-type method, and a hybrid-type method capable of switching between the ultra-short focus method and the projection-type method.

For example, in the case of a hybrid-type projector, a plurality of lenses (e.g., an ultra-short focus lens, a projection-type lens) may be provided in the projection part 130, and in response to a change in a projection method, a corresponding lens may be used to project an image.

According to one or more embodiments, the electronic apparatus 100 may project the test image through the projection part 130. For example, the electronic apparatus 100 may project the test image in order to adjust the projection area after being turned-on. Here, because the test image has been described above, redundant descriptions thereof will be omitted.

The processor 140 may control overall operations of the electronic apparatus 100. For example, the processor 140 may control an operation of the electronic apparatus 100 by being operatively connected with the memory 110, the sensor 120, and the projection part 130. In addition, the processor 140 may control, by executing one or more instructions stored in the memory 110, operations of the electronic apparatus 100 according to the disclosure. The processor 140 may be configured as one or a plurality of processors.

The processor 140 may be implemented with one or more integrated circuit (IC) (or circuitry) chips, and may execute various data processing. The processor 140 may include at least one electrical circuit, and may individually or collectively perform distributed processing of the instructions (or programs, data, etc.) stored in the memory 110. The processor 140 may include a processor assembly including one or more processing circuits. The processor 140 may include any operative processing circuitry for controlling performances and operations of the one or more elements (e.g., memory 110, sensor 120, and projection part 130) of the electronic apparatus 100. For example, the processor 140 (e.g., an application processor (AP)) may be implemented as a system on chip (SoC) (e.g., one chip or a chip set). For example, the processor 140 may be implemented as a plurality of cores (or at least one core circuit), a plurality of chips, or a plurality of chipsets. For example, the processor 140 may include one or more processing circuits. For example, the processor 140 may include one or more processing circuits configured to individually and/or collectively perform several functions of the disclosure. In an unlimited example, at least a portion of the processor 140 may be included in a first chip of the electronic apparatus 100, and at least another portion of the processor 140 may be included in a second chip of the electronic apparatus 100 different from the first chip of the electronic apparatus 100.

For example, the processor 140 may include a central processing unit (CPU), a graphics processing unit (GPU), a neural processing unit (NPU), an image signal processor (ISP), a display controller, a memory controller, a storage controller, a communication processor (CP), and/or a sensor interface. The elements of the processor 140 described above are merely examples. For example, the processor 140 may further include other elements. For example, some elements of the processor 140 may be omitted from the processor 140. For example, some elements of the processor 140 may be included as separate elements of the electronic apparatus 100 outside of the processor 140. For example, a portion of the elements (e.g., memory controller) of the processor 140 may be included in other elements (e.g., at least a portion of the memory 110, an interface (e.g., useable to connect to at least one element of the electronic apparatus 100), the projection part 130).

The processor 140 may cause other elements of the electronic apparatus 100 to perform various operations by executing the instructions stored in the memory 110. The CPU (or a central processing circuit) may be configured to control elements of the processor 140 based on the execution of instructions stored in the memory 110 (e.g., a volatile memory and/or a non-volatile memory). The GPU (or a graphics processing circuit) may be configured to execute parallel computations (e.g., rendering). The NPU (or a neural processing circuit, or an artificial intelligence (AI) chip) may be configured to execute computations (e.g., a convolution computation) for an artificial intelligence model. The ISP (or an image signal processing circuit) may be configured to process a raw image obtained through the image sensor in a format suitable for elements in the electronic apparatus 100 or elements of the processor 140. The display controller (or a display control circuit, or a display processing unit (DPU)) may be configured to process an image obtained from the CPU, the GPU, the ISP, or the memory 110 (e.g., volatile memory) in a format suitable for a display. The memory controller (or a memory control circuit) may be configured to control the reading of data from the volatile memory and the recording of data in the volatile memory. The storage controller (or a storage control circuit) may be configured to control the reading of data from the non-volatile memory and the recording of data in the non-volatile memory. The CP (or a communication processing circuit) may be configured to process data obtained from the elements of the processor 140 in a format suitable for transmitting to another electronic apparatus through a communication circuit, or process data obtained from the another electronic apparatus through the communication circuit in a format suitable for processing elements of the processor 140. For example, the communication circuit may include one or more communication circuits. The sensor interface (or a sensing data processing circuit, a sensor hub) may be configured to process data on a state of the electronic apparatus 100 and/or a surrounding state of the electronic apparatus 100 obtained through the sensor in a format suitable for elements of the processor 140.

For example, the processor 140 may perform, by executing one or more instructions stored in the memory 110, a method of the electronic apparatus 100 according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The processor 140 may be implemented as a single core processor that includes one core, or as one or more multicore processors that include a plurality of cores (e.g., a homogeneous multicore or a heterogeneous multicore). If the processor 140 is implemented as multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or a portion from among the plurality of cores) included in the multicore processors may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processors. For example, when a first operation, a second operation, and a third operation are performed by a method according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In the embodiments of the disclosure, the processor may refer to a system on chip (SoC), a single core processor, or a multicore processor in which the one or more processors and other electronic components are integrated, or a core included in the single core processor or the multicore processors, and the core herein may be implemented as the CPU, the GPU, the APU, the MIC, the DSP, the NPU, the hardware accelerator, the machine learning accelerator, or the like, but is not limited to the embodiments of the disclosure.

Meanwhile, the instructions stored in the above-described memory 110 may have the electronic apparatus 100 to perform the following operations when executed individually or collectively by the processor 140.

According to one or more embodiments, the electronic apparatus 100 may control the projection part 130 to project the test image. For example, the electronic apparatus 100 may control the projection part 130 to project the test image on the projection surface. Here, because the test image has been described above, redundant descriptions thereof will be omitted.

According to one or more embodiments, the electronic apparatus 100 may obtain a first area based on data corresponding to the projection surface on which the test image, which is obtained through the at least one sensor 120, is projected, while the test image is projected on the projection surface.

For example, the electronic apparatus 100 may acquire a first area on the projection surface based on data not obtained from infrared reflection. Here, the data not obtained from infrared reflection may be included in the data acquired through at least one sensor 120.

Here, the data corresponding to the projection surface on which the test image is projected may correspond to data (sensing data) obtained by the electronic apparatus 100 by sensing the projection surface on which the test image is projected through the at least one sensor 120.

Here, the sensing data may include RGB data and infrared data obtained from the projection surface. For example, the sensing data may correspond to an image captured by the electronic apparatus 100 of the projection surface through the RGB sensor and the infrared sensor.

The electronic apparatus 100 may obtain the infrared data by capturing the projection surface on which the test image is projected. If the electronic apparatus 100 fails correction based on the test image, obstacles and the like may be sensed from the projection surface based on infrared data. Here, the correction may mean the above-described keystone correction. However, the embodiment is not limited thereto. The above will be described in detail in the description below.

The electronic apparatus 100 may fail in correction based on the above-described test image even when a projectable area is smaller than an area on which the test image is projected. In this case, the electronic apparatus 100 may project a special test image on the projection surface.

Here, the special test image may correspond to an image different from the above-described test image. For example, if the test image is an image projected with infrared, the special test image may correspond to an image projected with visible rays.

The electronic apparatus 100 may obtain an image (IR+RGB image) by capturing the projection surface on which the special test image is projected. Here, the image may include both infrared data and RGB data.

The first area may correspond to an area for projecting an image from among the projection surface. Here, the area for projecting an image may mean an area obtained by adjusting the area on which the test image is projected by the electronic apparatus 100.

Here, adjusting the area on which the test image is projected may mean adjusting an area on which the test image is currently projected by the electronic apparatus 100 as the projectable area. Here, the projectable area may mean an area without distortion in the test image due to an obstacle or a sagged surface.

For example, the electronic apparatus 100 may identify a touch position of the user when an image (content image and the like other than the test image) is projected on the projectable area. That is, the electronic apparatus 100 may identify, based on a finger touch and the like of the user being present at a portion from among the projectable area, the touch position based on the received infrared.

Here, the received infrared may mean infrared received with the infrared sensor of the electronic apparatus 100 by being reflected by the finger touch and the like of the user. In this respect, because the same has been described in detail above, redundant descriptions thereof will be omitted.

According to an embodiment, the electronic apparatus 100 may obtain the first area which is smaller in size than the area on which the test image is projected from among the projection surface from data corresponding to the projection surface.

Here, the electronic apparatus 100 may obtain, based on the test image being projected on an area larger than the projectable area, the first area as the projectable area or an area smaller than thereof.

According to an embodiment, the electronic apparatus 100 may obtain an intersection image based on a plurality of images obtained from data corresponding to the projection surface. Here, the electronic apparatus 100 may obtain the intersection image by comparing the plurality of images. Here, the intersection image may correspond to an image generated by extracting a common feature or an overlapped area between the plurality of images.

For example, the electronic apparatus 100 may obtain a first image including pixel data obtained from the projection surface, from data corresponding to the projection surface obtained by the at least one sensor 120. Here, the pixel data obtained from the projection surface may correspond to data obtained by the electronic apparatus 100 by sensing the projection surface.

Here, the pixel data may correspond to data including information on brightness, color, or intensity value indicated by each pixel of the first image. For example, pixel data in an RGB image may include red (R), green (G), and blue (B) values. Pixels in an infrared image may include infrared reflection intensity (value).

The first image may correspond to an image including the above-described pixel data. For example, the first image may correspond to image obtained by sensing the projected test image and the projection surface.

Here, the first image may include a pattern distortion. Here, the pattern distortion may mean a change in pattern and the like indicated by an obstacle, a sagged surface, or a distortion of the lens of the projected correction pattern.

The electronic apparatus 100 may obtain the intersection image based on the first image and a second image.

Specifically, the electronic apparatus 100 may obtain the intersection image by comparing the first image and the second image. Here, the second image may correspond to an image obtained through the pixel data of the first image. Here, the image obtained through the pixel data of the first image may correspond to an image obtained by the electronic apparatus 100 by converting the pixel data of the first image.

For example, the second image may correspond to an image corrected by the electronic apparatus 100 of the distortion using pixel data of the first image as a camera eigenmatrix. Here, the second image may include a plurality of pixels divided according to a boundary of a work area.

Specifically, the electronic apparatus 100 may match a size of the area on which the test image is projected and a boundary from the first image with the work area. Here, the work area may mean an area predicted for the image to be appropriately projected from the projection surface.

At this time, the electronic apparatus 100 may remove obstacles and noise through morphological computation (e.g., eroding, dilating, etc.). Here, the morphological computation may mean a computation process of processing boundary, form, or noise by adding or removing pixels based on a structural form of an image.

For example, eroding may correspond to morphological computation of reducing bright pixels (e.g., white) and eroding away the boundary, and removing small noise or unnecessary portions in an image. Dilating may correspond to morphological computation of expanding the bright pixels and making the boundary thick, and filling in small holes or empty areas in an image.

The electronic apparatus 100 may obtain a boundary of the area on which the test image is projected through morphological computation, and adjust the boundary according to a boundary of a predicted work area.

Meanwhile, the electronic apparatus 100 may obtain the intersection image by comparing the first image and the second image. Here, the intersection image may correspond to an integrated image generated with common pixel data between the first image and the second image.

Specifically, the electronic apparatus 100 may set each pixel value such that a common pixel is less than a first threshold value by comparing pixel data of each of the first image and the second image, and a non-common pixel is greater than or equal to the first threshold value. Here, the first threshold value may correspond to a reference pixel value set to differentiate the common pixel and the non-common pixel in the intersection image.

Here, the common pixel may mean a pixel belonging also in a boundary in the second image from among an area belonging to the boundary in the first image. Here, the boundary in the first image may correspond to a boundary identified according to an area on which the test image is projected. The boundary in the second image may correspond to a boundary of the above-described work area.

Meanwhile, the non-common pixel may mean a pixel that does not belong in the boundary in the second image from among the area belonging to the boundary in the first image. The non-common pixel being present may mean that the boundary in the first image and the boundary in the second image are not a match.

That is, a process of the electronic apparatus 100 identifying the non-common pixel may correspond to a process of differentiating the projectable area with an exceeded area. Through the above, the electronic apparatus 100 may identify, based on the area on which the test image is projected being greater than the work area, the exceeded pixel value (pixel value of the non-common pixel) and identify whether a projection screen size adjustment is necessary.

The electronic apparatus 100 may obtain the intersection image formed of a plurality of pixels (including common pixels and non-common pixels). A relatively bright area in the intersection image may mean a non-common area. Conversely, a relatively dark area may mean a common area.

However, despite the embodiment as described above, the relatively bright area may also mean the common area, and the dark area may mean the non-common area.

According to an example, the electronic apparatus 100 may control the projection part 130 to reduce and project the test image based on at least one intersection pixel included in the obtained intersection image.

For example, the electronic apparatus 100 may reduce the test image to a reduced test image based on at least one intersection pixel included in the acquired intersection image.

The electronic apparatus 100 may also control the projection part 130 to project the reduced test image onto an area on the projection surface based on at least one intersection pixel of the acquired intersection image.

Here, the intersection pixel may mean the non-common pixel described above. That is, the intersection pixel may mean a pixel in which a pixel value in the intersection image is greater than or equal to the first threshold value.

For example, the electronic apparatus 100 may reduce the test image to the reduced test image based on a pre-set first unit and a number corresponding to the at least one intersection pixel being greater than or equal to a first threshold number, the at least one intersection pixel having a pixel value greater than or equal to a first threshold value.

For example, the electronic apparatus 100 may identify whether the at least one intersection pixel, in which a pixel value in the intersection image is greater than or equal to the first threshold value, is greater than or equal to the first threshold number.

Here, the first threshold number may mean a minimum number for identifying whether the test image is currently projected exceeding the work area.

The electronic apparatus 100 may control the projection part 130 to reduce and project the test image to a pre-set first unit based on the number corresponding to the at least one intersection pixel being greater than or equal to the first threshold number. For example, the number corresponding to the at least one intersection pixel may mean the number of the at least one of the intersection pixel.

Here, the first unit may correspond to a fixed reference value of a reduction rate, length, or width used when reducing the test image. The electronic apparatus 100 may reduce the size of the test image in stages according to the pre-set first unit.

The electronic apparatus 100 may control the projection part 130 to consecutively project the test image by reducing the size of the test image in stages.

Meanwhile, the electronic apparatus 100 may obtain as the first area, an area on the projection surface on which the reduced test image is projected.

Specifically, the electronic apparatus 100 may sense, based on the size reduced test image being projected, the projection surface, identify the intersection pixel from the first image and the second image, and reduce and project, based on the number of intersection pixels still being greater than or equal to the first threshold number, the test image again. The electronic apparatus 100 may repeatedly perform the above-described process of sensing the projection surface again.

For example, the electronic apparatus 100 may update a number of at least one intersection pixel based on the reduced test image. Specifically, the electronic apparatus 100 may obtain sensing data by sensing the projection surface on which the reduced test image is projected, and obtain the first image and the second image based on the sensing data.

The electronic apparatus 100 may identify the intersection pixel again from the intersection image obtained based on the first image and the second image, and change the existing number of the intersection pixels to a new number.

The electronic apparatus 100 may identify whether the updated number of the at least one intersection pixel is less than the first threshold number. If the number of the at least one intersection pixel is less than the first threshold number, the electronic apparatus 100 may obtain the area on which the reduced test image is projected as the first area.

That is, the electronic apparatus 100 may reduce the test image in stages, and repeatedly calculate the number of intersection pixels.

If the number of intersection pixels is identified as reduced to less than a specific number, the electronic apparatus 100 may identify the test image as being nearly a match with or included in the projectable area. In this case, the electronic apparatus 100 may obtain the area on which the test image is currently projected as the first area.

According to one or more embodiments, the electronic apparatus 100 may obtain a second area corresponding to image projection from among the projection surface based on the infrared data. Here, the infrared data may correspond to data obtained by the electronic apparatus 100 through infrared reflected from the projection surface from among data corresponding to the projection surface. Here, the data corresponding to the projection surface may correspond to the above-described sensing data.

For example, the infrared data may correspond to data obtained by sensing infrared radiation (IR) reflected by the projection surface by the electronic apparatus 100.

Here, the second area may correspond to an area for projecting an image (projectable area) by the electronic apparatus 100. The second area may be an area obtained by using only infrared data from among the sensing data, and may correspond to an area different from the first area.

According to an embodiment, the electronic apparatus 100 may identify at least one valid pixel in which a pixel value in the infrared image is greater than or equal to a second threshold value. Here, the infrared image may correspond to an image obtained from infrared data corresponding to the area on which the test image is projected.

Here, the infrared image may be based on infrared (IR) data obtained by infrared radiation reflected from the projection surface, and may correspond to an image which visually represents the reflection intensity, and the like of the surface.

For example, if the infrared radiation is reflected by an obstacle on the projection surface, the infrared image may include an obstacle area indicating a high infrared intensity. Here, the high infrared intensity may be indicated with relatively high pixel values in the infrared image.

The obstacle area may mean a set of pixels in which infrared data which is relatively strongly reflected by the obstacle is concentrated. Here, the pixels included in the set of pixels may mean a set of pixels having a higher reflection intensity than a normal projection surface (e.g., a plane such as a wall, a ceiling, or a floor).

Meanwhile, if infrared radiation is reflected by a sagged surface from among the projection surface, the infrared image may likewise include a sagged area indicating a high infrared intensity.

Meanwhile, the second threshold value may correspond to a reference value of an infrared intensity set to determine a pixel value in the infrared image indicating an obstacle or a sagged surface. For example, the second threshold value may be set such that a pixel value in the infrared image is 200 from among 255, and identify as infrared radiation being reflected by an obstacle or the like if the pixel value is greater than or equal to 200.

A valid pixel may correspond to a pixel in which a pixel value in the infrared image is identified as greater than or equal to the second threshold value. For example, an area occupied by the valid pixels may correspond to pixels indicating an area corresponding to an obstacle or a sagged surface.

Meanwhile, the electronic apparatus 100 may obtain the second area after identifying the valid pixels present in the infrared image.

According to an example, the electronic apparatus 100 may obtain the second area based on the identified at least one valid pixel from among the projection area.

In an example, the electronic apparatus 100 may identify whether a number of at least one valid pixel is greater than or equal to the second threshold number.

Here, the second threshold number may mean a minimum number of valid pixels (pixels greater than or equal to the second threshold value) in the infrared images. That is, the second threshold number may correspond to a criterion for determining whether an obstacle or a sagged area is present on the projection surface.

If the number of valid pixels is greater than or equal to the second threshold number, the electronic apparatus 100 may control the projection part 130 to reduce and project the test image to a pre-set second unit.

For example, the electronic apparatus 100 may control the projection part 130 to reduce the test image to a reduced test image based on a pre-set second unit and a number corresponding to the at least one valid pixel being greater than or equal to a second threshold number.

The electronic apparatus 100 may also control the projection part 130 to project the reduced test image on an area of the projection surface based on the at least one valid pixel.

Here, the second unit may mean a fixed unit set to reduce the test image. For example, the second unit may correspond to a ratio, area, or length unit. The electronic apparatus 100 may reduce the size of the test image in stages according to the pre-set second unit.

The electronic apparatus 100 may control the projection part 130 to sequentially project the test image by reducing the size of the test image in stages.

Meanwhile, the electronic apparatus 100 may obtain the second area based on the identified at least one valid pixel from among the projection surface.

Specifically, the electronic apparatus 100 may identify, based on the size reduced test image being projected, valid pixels from the infrared data obtained by sensing the projection surface, and reduce and project, based on the number of valid pixels still being greater than or equal to the second threshold number, the test image again. The electronic apparatus 100 may repeatedly perform the above-described process of sensing the projection surface again, and the like.

For example, the electronic apparatus 100 may update the number of the at least one valid pixel based on the reduced test image.

Specifically, the electronic apparatus 100 may obtain infrared data by sensing the projection surface on which the reduced test image is projected, identify the number of valid pixels again based on the infrared data, and change the existing number of valid pixels to a new number.

The electronic apparatus 100 may obtain the area on which the reduced test image is projected as the second area based on the updated number of the at least one valid pixel being less than the second threshold number. Here, the area on which the reduced test image is projected may be included in an area excluding the area occupied by the obstacle or the sagged surface from among the projection surface.

That is, the electronic apparatus 100 may reduce the test image in stages and repeatedly calculate the number of valid pixels.

If the number of intersection pixels is reduced to less than a specific number, the electronic apparatus 100 may identify as the test image having been projected avoiding the obstacle (or sagged surface). In this case, the electronic apparatus 100 may obtain the area on which the test image is currently projected as the second area.

According to one or more embodiments, the electronic apparatus 100 may obtain the projection area by comparing the first area and the second area. For example, the electronic apparatus 100 may obtain a small area from among the first area and the second area as the projection area.

According to an embodiment, the electronic apparatus 100 may obtain, based on an area of the small size from among the first area and the second area being greater than or equal to a defined threshold size, the area of the small size as the projection area. Here, the defined threshold size may correspond to a minimum size of the projection area set to correct minimal visibility of the projection area.

If the area of the small size from among the first area and the second area is less than or equal to the defined threshold size, the electronic apparatus 100 may end a work for obtaining the projection area.

Meanwhile, the electronic apparatus 100 may obtain a third area through a separate process for identifying an obstacle, and obtain the projection area based on the above-described first area and the second area, and the third area.

In an example, the electronic apparatus 100 may identify, through an artificial intelligence model, the at least one obstacle included on the projection surface based on data corresponding to the projection surface. Here, the data corresponding to the projection surface may correspond to data obtained by sensing the projection surface (sensing data).

Here, the artificial intelligence model may correspond to an artificial intelligence model corresponding to identification of at least one obstacle. The artificial intelligence model corresponding to the identification of an obstacle may correspond to an artificial intelligence model trained to identify an obstacle.

Specifically, the artificial intelligence model may correspond to a model trained to identify at least one obstacle included on a previous projection surface based on previous sensing data.

Here, the previous sensing data may correspond to sensing data obtained by sensing the previous projection surface by the electronic apparatus 100 or an external electronic apparatus before a current point in time. Here, the previous projection surface may mean a space which was subject to sensing before a current point in time by the electronic apparatus 100 or the external electronic apparatus.

For example, the electronic apparatus 100 or the external electronic apparatus may obtain the previous sensing data as training data by sensing the previous projection surface. The artificial intelligence model may be trained to identify an obstacle present on the previous projection surface by using the previous sensing data as training data.

The electronic apparatus 100 may obtain information on a position, a size, and the like of the obstacle present on the projection surface (current projection surface) by inputting data (currently obtained sensing data) corresponding to the projection surface in the artificial intelligence model.

Meanwhile, the electronic apparatus 100 may obtain sensing data based on each of a plurality of test images, and obtain the first area and the second area based on the obtained sensing data.

According to an embodiment, the electronic apparatus 100 may control the projection part 130 to project an initial test image including an infrared pattern. Here, the initial test image may correspond to a test image projected before the above-described test image is projected.

For example, the initial test image may include the infrared pattern. Here, the infrared pattern may correspond to a pattern projected through infrared radiation in order to analyze a size, boundary, obstacle, or sagged area of the projection surface. Here, the pattern may be sensed through the infrared sensor when projected on the projection surface and reflected.

According to an embodiment, the electronic apparatus 100 may control, based on a function associated with the infrared pattern not being performed, the projection part 130 to project the test image including an RGB pattern. Here, the function associated with the infrared pattern may correspond to a correction work which can be performed by the electronic apparatus 100 using the infrared pattern.

For example, it may be identified that the correction work (e.g., keystone correction work) using the infrared pattern has failed. In this case, the electronic apparatus 100 may control the projection part 130 to project the test image including the RGB pattern.

For example, based on an obstacle or a sagged surface being present on the projection surface, the electronic apparatus 100 may fail in correction based on the infrared pattern. Alternatively, if the projected infrared (infrared pattern) reflection is weak or if interference by ambient light is significant, the electronic apparatus 100 may fail in correction due to the IR sensor not being able to accurately sense the boundary of the projection surface.

In addition, the electronic apparatus 100 may fail in correction if the area on which the test image is projected is bigger than a projectable surface (work area).

In this case, the electronic apparatus 100 may control the projection part 130 to project a new test image including the RGB pattern. Here, the RGB pattern may correspond to a pattern for analyzing the size, boundary, and distortion of the projection surface. The RGB pattern may be implemented in a color image form configured with red (R), green (G), and blue (B) channels.

Here, the test image may include both the RGB pattern and the infrared pattern. In this case, the sensing data obtained while the test image is projected may include both the RGB data and the infrared data.

For example, if the electronic apparatus 100 fails in correction using the infrared pattern, the electronic apparatus 100 may project a full-white test image on the projection surface. The electronic apparatus 100 may perform connection for the projection area based on the full-white test image rather than the infrared pattern.

The electronic apparatus 100 may project the test image including the RGB pattern on the projection surface, and obtain the first area based on the sensing data which sensed the projection surface. Here, because the operation for obtaining the first area has been described in detail above, redundant descriptions thereof will be omitted.

Then, the electronic apparatus 100 may obtain the second area based on infrared data from among data corresponding to the projection surface obtained through the projection surface on which the initial test image is projected.

For example, the electronic apparatus 100 may obtain the second area based on infrared data from among the sensing data obtained by sensing the projection surface on which the initial test image is projected. That is, if the electronic apparatus 100 obtains the second area, rather than the projection surface on which a (new) test image is projected, the second area may be obtained by sensing the projection surface on which the initial test image is projected.

Meanwhile, the electronic apparatus 100 may obtain the third area included in the area excluding the area corresponding to the obstacle from among the projection surface. For example, the electronic apparatus 100 may obtain, from among the area excluding the area occupied by the obstacle from among the projection surface, the third area which is of a same ratio as a ratio of the area on which the test image is currently projected.

Here, the electronic apparatus 100 may be same as the ratio of the area on which the test image is projected, and obtain an area with a maximum size as the third area. The electronic apparatus 100 may compare the first area, the second area, and the third area and obtain the projection area.

Through the above, the electronic apparatus 100 may obtain the area excluding the obstacle on the projection surface as the second area, but a suitable projection position may be obtained by more accurately identifying obstacles using the artificial intelligence model for obstacle detection.

As described above, the electronic apparatus 100 may obtain the first area and the second area when the test image is projected on the projection surface, and obtain the projection area by comparing the two areas.

Through the above, the electronic apparatus 100 may obtain a more suitable projection area for projecting an image compared to obtaining the projection area through only a single process (e.g., one from among a process of obtaining the first area and a process of obtaining the second area). That is, because the electronic apparatus 100 can obtain a more accurate projection area even if there are interfering elements (obstacle or sagged surface, etc.) which were not sensed, user satisfaction of the electronic apparatus 100 may be further increased.

In FIG. 2, although the electronic apparatus 100 including only basic configurations is shown, but the electronic apparatus 100 may further include various configurations in addition to the above-described configurations.

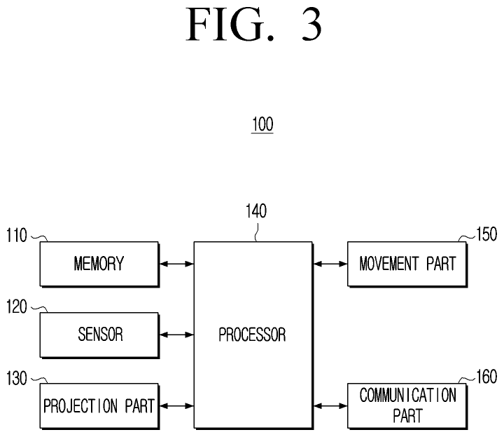

FIG. 3 is a detailed block diagram illustrating a detailed configuration of an electronic apparatus according to one or more embodiments of the disclosure.

Referring to FIG. 3, the electronic apparatus 100 may include the memory 110, the sensor 120, the projection part 130, the processor 140, a movement part 150, and a communication part 160. Here, because the memory 110, the sensor 120, the projection part 130, and the processor 140 have already been described, redundant descriptions thereof will be omitted and described.

The movement part 150 may be a configuration for moving the electronic apparatus 100. To this end, the movement part 150 may include a motor, wheels, and the like, and may move the electronic apparatus 100 through movement of the wheels. Meanwhile, at implementation, a caterpillar and the like may be used in place of the wheels, and if the electronic apparatus 100 is implemented as a drone or the like, a propeller may be used in place of the wheels.

According to an embodiment, the electronic apparatus 100 may control the movement part 150 to move from a current position to a second projection position.

Here, the current position may mean a position corresponding to the projection of the test image. Here, the position corresponding to the projection of the test image may correspond to a position for projecting the test image by the electronic apparatus 100.

A second position may correspond to a position corresponding to image projection on a projection area. Here, the position corresponding to the image projection on the projection area may correspond to a position for projecting an image (an image rather than the test image) on the projection area by the electronic apparatus 100.

Specifically, the second position may correspond to a position from which the electronic apparatus 100 is able to face a center of the projection area. Here, the second position may be present within a focal range from the projection surface (e.g., wall). Here, the focal range may mean a range between a minimum distance and a maximum distance of which the electronic apparatus 100 is able to project an image clearly and without distortion on the projection surface.

For example, the second position may correspond to a position for projecting an image from the center of the projection area. Alternatively, the second position may correspond to a position at which an image can be projected on the projection area avoiding surrounding obstacles (e.g., a floor surface for driving the electronic apparatus 100).

Specifically, the electronic apparatus 100 may obtain the second position and a path toward the second position based on the projection area and sensing data.

For example, the electronic apparatus 100 may analyze the sensing data obtained from the projection surface, and generate map information including the position of the projection area and surrounding obstacle information. The electronic apparatus 100 may obtain an optimized path from the current position to the second position based on the map information. Here, the map information may include the size of the projection surface, the boundary, the obstacle position, and coordinates of the projection area.

Meanwhile, the communication part 160 may be a configuration for performing communication with external devices of various types according to communication methods of various types. The communication part 160 may include a Wi-Fi module, a Bluetooth module, an infrared communication module, a wireless communication module, and the like. Here, each communication module may be implemented in at least one hardware chip form.

The Wi-Fi module and the Bluetooth module may perform communication in a Wi-Fi method and a Bluetooth method, respectively. When using the Wi-Fi module or the Bluetooth module, various connection information such as a service set identifier (SSID) and a session key may first be transmitted and received, and after communicatively connecting using the same, various information may be transmitted and received.

The infrared communication module may perform communication according to an infrared communication (Infrared Data Association (IrDA)) technology of transmitting data wirelessly in short range by using infrared radiation present between visible rays and millimeter waves.

The wireless communication module may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

In addition thereto, the communication part 160 may include at least one from among the wired communication modules that perform communication using a local area network (LAN) module, an Ethernet module, a pair cable, a coaxial cable, an optical fiber cable, an Ultra Wide-Band (UWB) module, or the like. The communication part 160 as described may be referred to as a transceiver.

For example, the electronic apparatus 100 may receive, from the external electronic apparatus, sensing data obtained by sensing the projection surface by the external electronic apparatus through the communication part 160. Alternatively, the electronic apparatus 100 may receive data regarding the first area and the second area obtained by the external electronic apparatus 100 through the communication part 160.

In this case, the electronic apparatus 100 may transmit sensing data obtained by sensing the projection surface surrounding the electronic apparatus 100 to the external electronic apparatus, and receive data on the first area and the second area from the external electronic apparatus. However, the embodiment is not limited thereto.

Meanwhile, in FIG. 3, although the electronic apparatus 100 included with various additional configurations has been shown, a portion of the configurations from among the shown configurations may be implemented omitted. In addition, although not shown, other configurations may be further included.

For example, the electronic apparatus 100 may further include, a communication part.

For example, the communication part may perform data communication between the external device and the electronic apparatus using at least one from among data communication methods including a wired LAN, a wireless LAN, Wi-FI, Wi-Fi Direct, Bluetooth, ZigBee, Wi-Fi Direct (WFD), infrared communication (infrared Data Association, IrDA), Bluetooth Low Energy (BLE), Near Field Communication (NFC), Wireless Broadband Internet (Wibro), World Interoperability for Microwave Access (WiMAX), Shared Wireless Access protocol (SWAP), Wireless Gigabit Alliances (WiGig), and RF communication.

In addition, the communication part may perform communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

Meanwhile, the processor 140 may receive a signal for obtaining the projection area based on the first area and the second area from a server and the like through the communication part.

Alternatively, the processor 140 may transmit a signal requesting for data on the first area and the second area to the server and the like through the communication part. For example, the processor 140 may obtain the projection area based on the received data and the like on the first area and the second area.

Meanwhile, the processor 140 may receive a control signal for the electronic apparatus 100 to identify the projection area based on the first area and the second area from a server device, and the like. However, the embodiment is not limited thereto.

Meanwhile the electronic apparatus 100 may be connected with the external device or servers and further include an interface such as a HDMI port, a DP, an RGB, a DVI, a USB, a thunderbolt, and the like for receiving video/audio signals. The HDMI, the DP, and the thunderbolt may be a port with which video and audio signals may be simultaneously transmitted. The electronic apparatus 100 may output distance information and second map data by performing various processing such as demuxing, decoding, scaling, and the like for various signals received from the external device and the server and the like that perform communication with the external device through the communication part and the various interfaces described above.

Meanwhile, the electronic apparatus 100 may include a display.

The display may be a configuration for displaying an operation state or notification message of the electronic apparatus 100, a UI screen, and the like. The display may be implemented as a display of various forms such as a Liquid Crystal Display (LCD), an Organic Light Emitting Diode (OLED) display, a Plasma Display Panel (PDP), and the like. In the display, a driving circuit, which may be implemented in a form of an amorphous silicon thin film transistor (a-si TFT), a low temperature poly silicon (LTPS) TFT, an organic TFT (OTFT), or the like, a backlight unit, and the like may be included. Meanwhile, the display may be implemented as a touch screen coupled with a touch sensor, a flexible display, a three-dimensional display (3D display), or the like. Alternatively, the display may be implemented with one or a plurality of light emitting devices.

The electronic apparatus 100 may change a display state of the display such that the user may intuitively identify the state of the electronic apparatus 100 according to the various states such as the electronic apparatus 100 being in a turned-on state, being in a normally operating state, being in a state of power shortage or in an error state, or the like.

For example, the processor 140 may control the display to display a UI corresponding to the obtained first area. Here, the UI corresponding to the first area may correspond to a graphic element which visually represents the first area in an overlapped form on the captured projection surface.

However, the embodiment is not limited thereto, and the processor 140 may control the display to display an image of the projection surface before obtaining the first area or the second area.

However, the display configuration is merely a portion from among the various embodiments, and the display configuration may be omitted. That is, the electronic apparatus 100 may be an apparatus which directly includes the display, or an apparatus connected with the external device.

For example, if the electronic apparatus 100 is implemented as a set top box, a one connected box, a projector, or the like, operations of the above-described electronic apparatus 100 may be performed from an electronic apparatus that does not include the display.

In this case, the processor 140 may obtain a UI or the like based on a first projection area, and provide the obtained UI to an external display device (an apparatus including the display) through the communication part. The external display device may display the provided UI through a display provided in the external display device.

Meanwhile, the electronic apparatus 100 may include a microphone.

The microphone may receive a voice of the user in an activated state. For example, the microphone may be integrally formed at an upper side or a front surface direction, a side surface direction, or the like of the electronic apparatus 100.

The microphone may include various configurations such as a microphone that collects a user voice in an analog form, an amplifier circuit that amplifies the collected user voice, an A/D converter circuit that samples the amplified user voice and converts to a digital signal, a filter circuit that removes noise components from the converted digital signal, and the like.

The microphone may transmit the received user voice to the electronic apparatus 100. Then, the electronic apparatus 100 may perform voice recognition by inputting the received user voice in a voice recognition model. For example, the electronic apparatus 100 may perform Speech to Text (STT) to the user voice, and perform voice recognition on the user voice. The microphone may receive the user voice, and transmit the received user voice to the electronic apparatus 100. Then, the electronic apparatus 100 may perform the voice recognition by inputting the received user voice in the voice recognition model. For example, the electronic apparatus 100 may perform voice recognition on the user voice by performing Speech to Text (STT) to the user voice.

For example, the processor 140 may receive a user input through the microphone as a user input. Here, the user input may correspond to a user input for obtaining the projection area. However, the embodiment is not limited thereto.

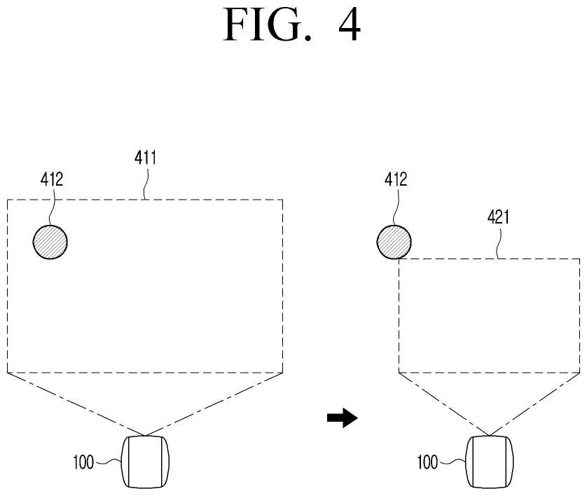

FIG. 4 is a diagram illustrating an operation of an electronic apparatus according to one or more embodiments of the disclosure.

Referring to FIG. 4, an initial area 411 and a final area 421 may be shown.

Here, the initial area 411 may correspond to the area on which the electronic apparatus 100 projects the test image. Here, because the test image has been described in detail above, redundant descriptions thereof will be omitted.

The electronic apparatus 100 may obtain the final area 421 avoiding an obstacle 412 by adjusting the initial area 411. The electronic apparatus 100 may project the test image or a content image at the final area 421.

Specifically, the electronic apparatus 100 may project the test image on the projection surface, and obtain sensing data by sensing the initial area 411 at which the test image is projected. Here, the sensing data may include at least one from among the infrared data and the RGB data.

The electronic apparatus 100 may identify whether the obstacle 412 is present from the sensing data.

Specifically, the electronic apparatus 100 may identify the obstacle 412 based on a plurality of images (e.g., first image and second image) obtained from the sensing data. Alternatively, the electronic apparatus 100 may identify the obstacle 412 based on the infrared image obtained from the infrared data.

The electronic apparatus 100 may reduce a size of the initial area 411 in stages based on the position of the obstacle 412 and obtain the final area 421 which satisfies a specific condition. Here, the final area 421 may correspond to the projection area obtained by the electronic apparatus 100 based on the first area and the second area. Here, the specific condition may mean a condition in which a number of intersection pixels or a number of valid pixels are less than a specific number.

Because an operation of the electronic apparatus 100 obtaining the final area 421 based on pixel values of various types has been described above, redundant descriptions thereof will be omitted.

The electronic apparatus 100 may project an image at the obtained final area 421, and when a new obstacle is generated or if a sagged surface is generated at the final area thereafter, the final area 421 may be newly adjusted.

According to the above-described example, here, the electronic apparatus 100 may obtain the final area 421 by adjusting the initial area 411 from a fixed position without moving, and project an image at the obtained final area 421. However, the embodiment is not limited thereto, and the electronic apparatus 100 may project an image at the final area 421 by moving to a different position as described below.

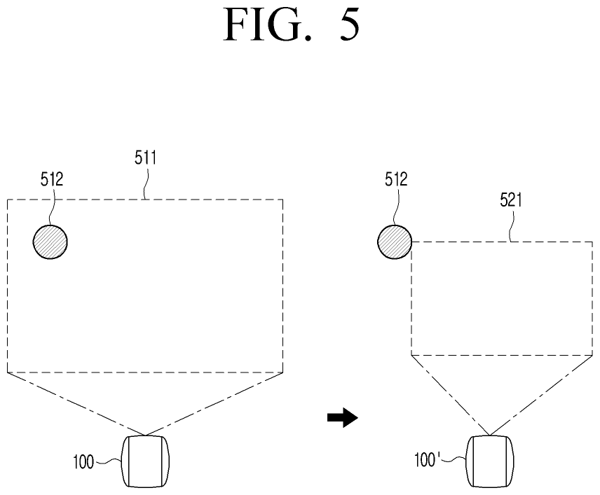

FIG. 5 is a diagram illustrating a movement of an electronic apparatus according to one or more embodiments of the disclosure.

Referring to FIG. 5, an initial area 511 and a final area 521 are shown.

The electronic apparatus 100 may obtain the final area 521 by adjusting the initial area 511. The electronic apparatus 100 may project the test image or a content image at the final area 521.

Here, the electronic apparatus 100 may project an image at the final area 521 by moving to a new position. Here, the new position may mean the above-described second position.

After moving, the electronic apparatus 100′ may project an image at the final area 521 from the new position. Here, the new position may correspond to a position obtained based on the position of the final area 521.

The electronic apparatus 100 may project an image at the final area 521 from a position facing a front of the center of the final area 521. Here, the position facing the front may be positioned within a focal range from a center point of the final area 521. Because the focal range and the like has been described above, redundant descriptions thereof will be omitted.

Meanwhile, the electronic apparatus 100 may identify that an obstacle is present at the new position (e.g., position facing the front) based on the sensing data. For example, the electronic apparatus 100 may identify an obstacle based on map information obtained from the sensing data. In this case, the electronic apparatus 100 may move to a close position from the obstacle.

Here, because destination, path, and the like for the electronic apparatus 100 to move have been described above, redundant description thereof will be omitted.

After moving, the electronic apparatus 100′ may project an image at the final area 521. At this time, if a distortion (e.g., keystone, etc.) occurs at the final area 521 at which the image is projected, additional correction (e.g., keystone correction) may be performed.

Accordingly, the electronic apparatus 100 may project an image from the position facing the center of the final area 521 in order to minimize distortion by the projection position, and if an obstacle is present at the corresponding position, the electronic apparatus 100 may project the image at the final area by moving to a position avoiding the obstacle.

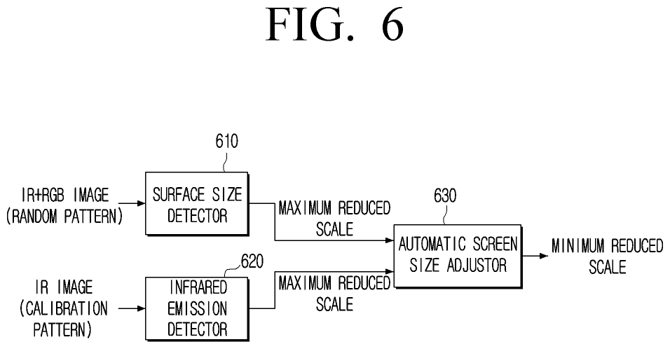

FIG. 6 is a diagram illustrating a maximum reduced scale according to one or more embodiments of the disclosure.

Referring to FIG. 6, a surface size detector 610, an infrared emission detector 620, and an automatic screen size adjustor 630 are shown.

The electronic apparatus 100 may include the surface size detector 610, the infrared emission detector 620, and the automatic screen size adjustor 630. At this time, the electronic apparatus 100 may obtain the above-described final area using a plurality of types of images as input data.

The surface size detector 610 may generate data for adjusting the screen size by obtaining the size and boundary of the projectable area. The surface size detector 610 may receive an IR+RGB image.

Here, the IR+RGB image may correspond to an image obtained by sensing the projection surface on which a random pattern is projected. Here, the random pattern may mean the RGB pattern. For example, the RGB pattern may mean the above-described full-white test image. For example, the electronic apparatus 100 may project the full-white test image if correction based on the infrared pattern has failed.

The electronic apparatus 100 may output data including information on the size and boundary of the projectable area based on the IR+RGB image. For example, the electronic apparatus 100 may output data including information on the maximum reduced scale.

Here, the maximum reduced scale may mean a maximum scale from among the scale reduced to fit the projectable area when a pattern is projected exceeding the projectable area. Here, the maximum reduced scale ma correspond to the above-described first area.

For example, the maximum reduced scale may correspond to an area which a size reduced pattern (test image) can occupy maximally in the projectable area while maintaining an original ratio. However, the embodiment is not limited thereto.

The infrared emission detector 620 may obtain data for adjusting the projection area according to an area occupied by an obstacle or the like. The surface size detector 610 may receive the infrared image (IR image).

Here, the IR image may correspond to an image obtained by sensing the projection surface on which a calibration pattern is projected. Here, the calibration pattern may correspond to a pattern for analyzing the size, boundary, obstacle, or sagged area of the projection surface.

For example, the electronic apparatus 100 may project the calibration pattern on the projection surface through infrared radiation in order to identify obstacles and the like. The infrared sensor of the electronic apparatus 100 may receive infrared radiation reflected by the calibration pattern. Because the same was described above, redundant descriptions thereof will be omitted.

The electronic apparatus 100 may output data including information on the size and boundary of the projectable area based on the IR image. Here, the projectable area may correspond to an area included in an area that excludes obstacles and the like identified by infrared data.

For example, the electronic apparatus 100 may output data including information on the maximum reduced scale. Here, the maximum reduced scale may mean, if an obstacle, a sagged surface, or the like is included in the area at which the pattern is projected, the maximum scale from among the scale reduced to fit the projectable area. Here, the maximum reduced scale may correspond to the above-described second area.

For example, the maximum reduced scale may correspond to the area which the size reduced pattern (test image) can occupy maximally in the projectable area while maintaining the original ratio. However, the embodiment is not limited thereto.

Meanwhile, the automatic screen size adjustor 630 may obtain an optimal area by automatically adjusting the screen size based on surface size and obstacle information. Here, the screen size may mean the size of the projectable area from among data output by the surface size detector 610.

Here, the obstacle information may correspond to information included in data output by the infrared emission detector 620. For example, the obstacle information may mean information on the position, size, and form of the obstacle sensed based on the infrared data from the projection surface.

Meanwhile, the automatic screen size adjustor 630 may receive output data of each of the surface size detector 610 and the infrared emission detector 620.

For example, the automatic screen size adjustor 630 may receive both the information on the maximum reduced scale output by the surface size detector 610 and the information on the maximum reduced scale output by the infrared emission detector 620.

The automatic screen size adjustor 630 may obtain a minimum reduced scale based on input data as described above. Here, the minimum reduced scale may mean a minimum scale greater than or equal to a minimum scale (threshold size) from among a plurality of maximum reduced scales output by each of the surface size detector 610 and the infrared emission detector 620.

The automatic screen size adjustor 630 may identify a minimum value by comparing the two received maximum reduced scales. The automatic screen size adjustor 630 may output the minimum value to the maximum reduced scale if the minimum value is greater than or equal to a threshold size by comparing the minimum value with the threshold size. Here, because the threshold size has been described above, redundant descriptions thereof will be omitted.

As described above, the electronic apparatus 100 may obtain the two maximum reduced scales by different methods through each of the surface size detector 610 and the infrared emission detector 620. The electronic apparatus 100 may obtain the minimum reduced scale corresponding to the final projection area by comparing the two maximum reduced scales.

Through the above, the electronic apparatus 100 may obtain the final area more accurately avoiding the elements (obstacle, sagged surface, etc.) that interfere with projection.

Meanwhile, the electronic apparatus 100 may obtain the final area additionally using separate modules in addition to the surface size detector 610 and the infrared emission detector 620.

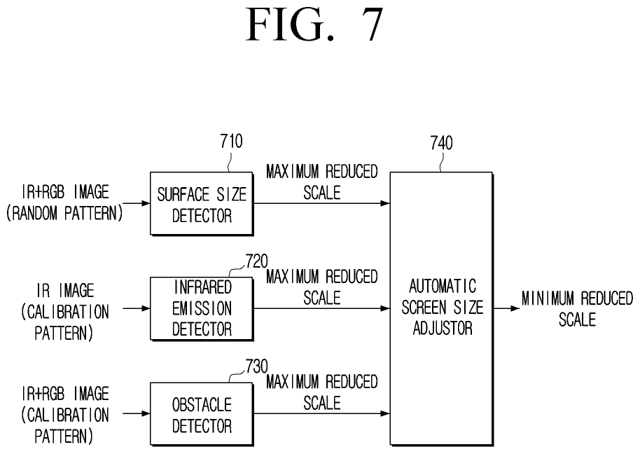

FIG. 7 is a diagram illustrating an obstacle detector according to one or more embodiments of the disclosure.

Referring to FIG. 7, a surface size detector 710, an infrared emission detector 720, an obstacle detector 730, and an automatic screen size adjustor 740 are shown.

Here, the surface size detector 710 and the infrared emission detector 720 may perform the same function as the surface size detector 610 and the infrared emission detector 620 described in FIG. 6, respectively. In FIG. 7, redundant descriptions on the above-described configurations will be omitted, and operations of the obstacle detector 730 and the automatic screen size adjustor 740 will be described in detail.

The obstacle detector 730 may sense the position and size of the obstacle and obtain data for adjusting the projection area according to the area occupied by the obstacle. The obstacle detector 730 may receive the IR+RGB image.

Here, the IR+RGB image may correspond to an image obtained by sensing the projection surface on which the calibration pattern is projected. Here, the calibration pattern may mean a pattern for identifying obstacles and the like. The electronic apparatus 100 may project the calibration pattern on the projection surface through at least one from among infrared radiation and visible rays in order to identify obstacles and the like.

The electronic apparatus 100 may output data including information on the size and boundary of the projectable area based on the IR+RGB image. Here, the projectable area may correspond to an area included in the area excluding obstacles and the like identified through the artificial intelligence model.

Here, the neural network model may correspond to a model trained to identify obstacles present on the projection surface based on sensing data. Because detailed descriptions on this artificial intelligence model have been described above, redundant descriptions thereof will be omitted.

For example, the electronic apparatus 100 may output data including information on the maximum reduced scale as output data. Here, the maximum reduced scale may mean a maximum scale from among the scale reduced to fit the projectable area when an obstacle is included in the area at which the pattern is projected. Here, the maximum reduced scale may correspond to the above-described third area.

For example, the maximum reduced scale may correspond to the area which the size reduced pattern (test image) can occupy maximally in the projectable area while maintaining an original ratio. However, the embodiment is not limited thereto.

Meanwhile, the automatic screen size adjustor 740 may receive output data of each of the surface size detector 710, the infrared emission detector 720, and the obstacle detector 730.

For example, the electronic apparatus 100 may receive all of the information on the maximum reduced scale output by the surface size detector 710, the information on the maximum reduced scale output by the infrared emission detector 720, and the information on the maximum reduced scale output by the obstacle detector 730.

The automatic screen size adjustor 740 may obtain a minimum reduced scale based on input data as described above. Here, the minimum reduced scale may mean a minimum scale greater than or equal to the minimum scale (threshold size) from among the plurality of maximum reduced scales output by each of the surface size detector 710, the infrared emission detector 720, and the obstacle detector 730.

The automatic screen size adjustor 740 may identify the minimum value by comparing the three received maximum reduced scales. The automatic screen size adjustor 740 may output the minimum vale as the maximum reduced scale if the minimum value is greater than or equal to the threshold size by comparing the minimum value with the threshold size.

As described above, the electronic apparatus 100 may not only obtain the maximum reduced scale through the surface size detector 710 and the infrared emission detector 720, but also through the obstacle detector 730. The electronic apparatus 100 may obtain the minimum reduced scale corresponding to the final projection area by comparing the three maximum reduced scales.

Through the above, the electronic apparatus 100 may more accurately identify an obstacle through the artificial intelligence model for obstacle detection, and obtain a more optimized final area.

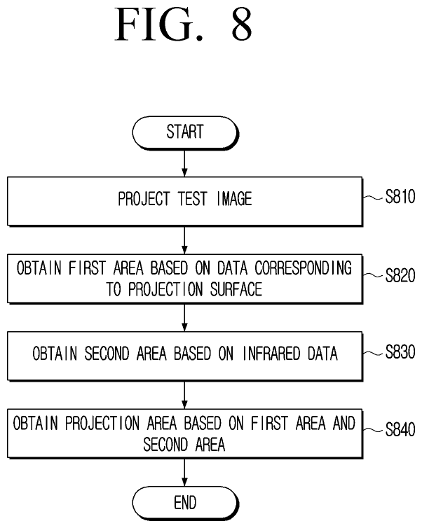

FIG. 8 is a flowchart illustrating a controlling method of an electronic apparatus according to one or more embodiments of the disclosure.

The electronic apparatus 100 may project the test image (S810).

Then, the electronic apparatus 100 may obtain the first area based on data corresponding to the projection surface on which the test image is projected (S820).

According to one or more embodiments, the electronic apparatus 100 may obtain the first area based on data corresponding to the projection surface on which the test image is projected.

According to an embodiment, the electronic apparatus 100 may obtain the first area which is a smaller size than the area at which the test image is projected from among the projection surface based on data corresponding to the projection surface.

Then, the second area may be obtained based on infrared data from among the sensing data (S830).

According to one or more embodiments, the electronic apparatus 100 may obtain the second area corresponding to image projection from among the projection surface based on infrared data obtained through infrared radiation reflected from the projection surface from among data corresponding to the projection surface.

According to an embodiment, the electronic apparatus 100 may identify at least one valid pixel in which a pixel value in the infrared image obtained from infrared data corresponding to the area at which the test image is projected is greater than or equal to the second threshold value.

Then, the electronic apparatus 100 may obtain the second area based on the identified at least one valid pixel from among the projection surface.

Then, the electronic apparatus 100 may obtain the projection area based on the first area and the second area (S840).

According to an embodiment, the electronic apparatus 100 may obtain, based on the small size area from among the first area and the second area being greater than or equal to the defined threshold size, the small size area as the projection area.

The electronic apparatus 100 may obtain, as described above, both the first area and the second area using different methods, respectively, and obtain the final area by comparing the first area and the second area. With respect to an operation of the electronic apparatus 100 obtaining the final area below, operations of the surface size detector, the infrared emission detector, the obstacle detector, and the like will be described.

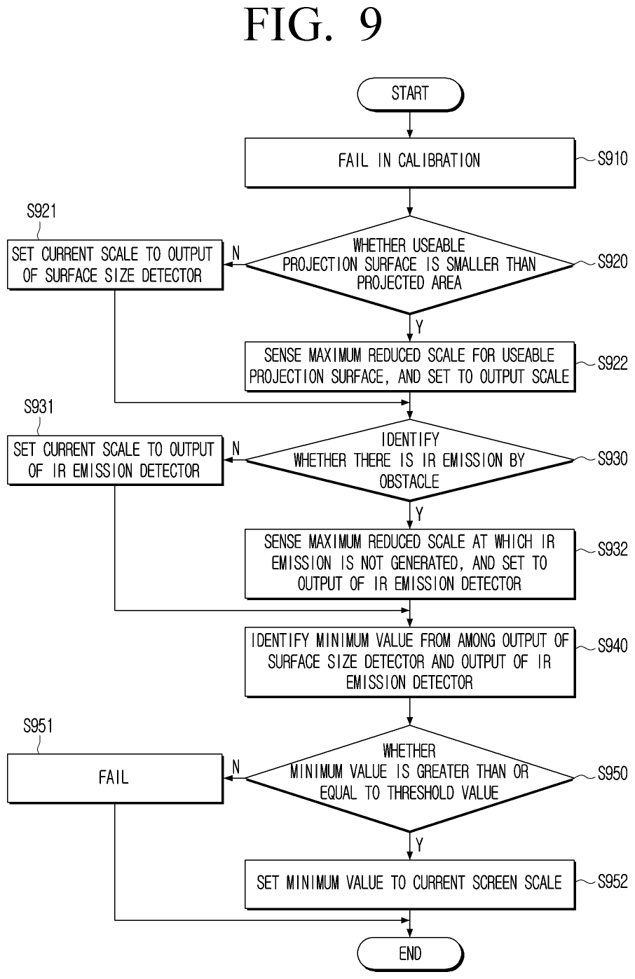

FIG. 9 is a flowchart illustrating an operation of an electronic apparatus using a surface size detector and an infrared emission detector according to one or more embodiments of the disclosure.

The electronic apparatus 100 may fail in calibration (S910). For example, the electronic apparatus 100 may fail in calibration when distortion occurs on the projection surface. Here, the distortion occurring on the projection surface may mean an obstacle, a sagged surface, or the like being present on the projection surface or there being an object present interfering with projection between the electronic apparatus 100 and the projection surface.

Then, the electronic apparatus 100 may identify whether a useable projection surface is smaller than a projected area (S920). For example, the electronic apparatus 100 may identify whether the useable projection surface is smaller than the projected area using the surface size detector.

Here, the projected area may mean an area at which the test image is projected. Here, the test image may mean the calibration pattern. The useable projection surface may mean the projectable area. For example, the surface size detector may identify the useable projection surface from the plurality of images (e.g., first image and second image) obtained from the sensing data.

If the projected area is a match with the useable projection surface or is bigger than the useable projection surface, the electronic apparatus 1z00 may set a current scale to an output of the surface size detector (S921). Here, the current scale may mean a currently projected area, that is, an area at which a current test image is projected on the projection surface.

If the projected area is smaller than the useable projection surface, the electronic apparatus 100 may sense the maximum reduced scale for the useable projection surface, and set the maximum reduced scale to the output of the surface size detector (S922).

For example, the electronic apparatus 100 may reduce the size of the test image in stages, and identify a maximum size of the test image included in the useable projection surface. The electronic apparatus 100 may obtain, based on identifying the maximum size test image included in the useable projection surface, an area at which the corresponding test image (reduced test image) is projected as the maximum reduced scale.

Then, the electronic apparatus 100 may identify whether there is infrared (IR) emission by the obstacle (S930). For example, the electronic apparatus 100 may identify whether there is IR emission projected using the infrared emission detector.

Here, if IR emission is present, the infrared radiation may be reflected by the projection surface and received in the electronic apparatus 100. Alternatively, the electronic apparatus 100 may sense whether there is IR emission due to a sagged surface.

If IR emission by an obstacle is not present, the electronic apparatus 100 may set the current scale to an output of the IR emission detector (S931).

Conversely, if IR emission by an obstacle is present, the electronic apparatus 100 may sense the maximum reduced scale at which IR emission is not generated, and set the maximum reduced scale as the output of the IR emission detector (S932).

For example, the electronic apparatus 100 may reduce the size of the test image in stages, and identify the maximum size test image at which the IR emission is not generated. Here, the IR emission not being generated may mean that a number of valid pixels is less than a threshold number (e.g., second threshold number). Here, because the valid pixels, the second threshold number, and the like have been described in detail above, redundant descriptions thereof will be omitted.

The electronic apparatus 100 may obtain, based on identifying the maximum size test image at which IR emission is not generated, the area at which the corresponding test image (reduced test image) is projected as the maximum reduced scale.

Then, the electronic apparatus 100 may identify the minimum value from among the output of the surface size detector and the output of the IR emission detector (S940). For example, the electronic apparatus 100 may identify the minimum value from among the maximum reduced scale output by the surface size detector and the maximum reduced scale output by the IR emission detector.

Then, whether the minimum vale is greater than or equal to the threshold value may be identified (S950), and the electronic apparatus 100 may identify that the correction work has failed if the minimum value is less than the threshold value (S951). Here, the correction work may mean work of obtaining the final area by adjusting the current projection area.

If the minimum value is greater than or equal to the threshold value, the electronic apparatus 100 may set the minimum value to a current screen scale (S925). The electronic apparatus 100 may adjust the projection area based on the current screen scale, and project the test image or the content image on the adjusted projection area (final area).

According to that described above, the electronic apparatus 100 obtaining the output of the IR emission detector after obtaining the output of the surface size detector has been described as an example, but is not necessarily limited thereto.

For example, the electronic apparatus 100 may perform a process of obtaining the output of the surface size detector and a process of obtaining the output of the IR emission detector in parallel. Alternatively, the electronic apparatus 100 may sequentially obtain the output of the surface size detector after obtaining the output of the IR emission detector.

Meanwhile, referring to FIG. 9, although the electronic apparatus 100 may obtain the final area using the surface size detector and the IR emission detector, the final area may be obtained using separate modules together therewith.

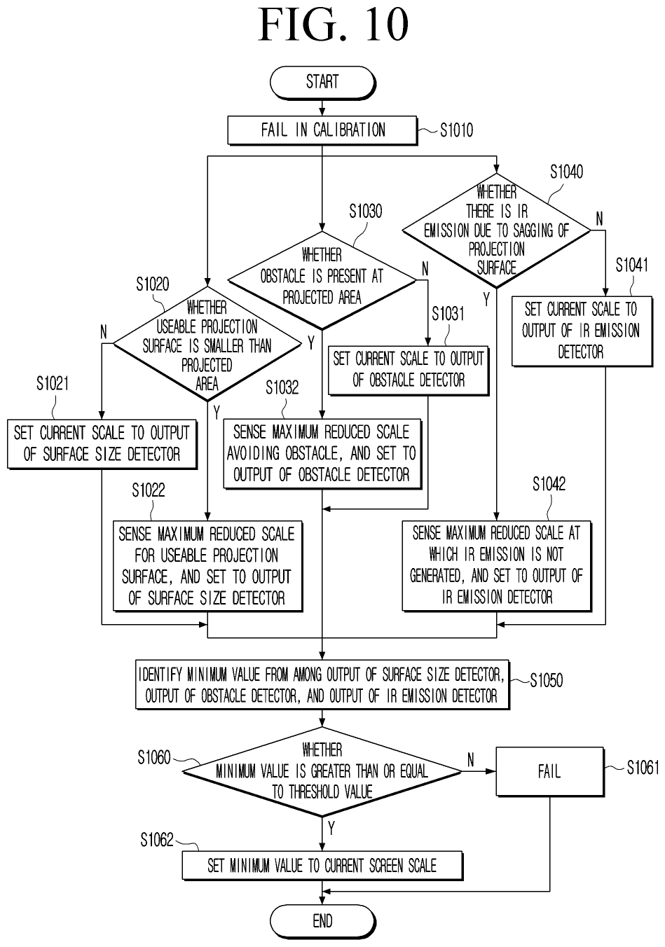

FIG. 10 is a diagram illustrating an operation of an electronic apparatus using an obstacle detector according to one or more embodiments of the disclosure.

The electronic apparatus 100 may fail in calibration (S1010). Because the failing in calibration has been described in FIG. 9, redundant descriptions thereof will be omitted.

Then, the electronic apparatus 100 may identify whether the useable projection surface is smaller than the projected area (S1020). If the projected area is a match with the useable projection surface or is bigger than the useable projection surface, the electronic apparatus 100 may set the current scale to the output of the surface size detector (S1021).

If the projected area is smaller than the useable projection surface, the electronic apparatus 100 may sense the maximum reduced scale for the useable projection surface, and set the maximum reduced scale to the output of the surface size detector (S1022). Because the above-described operation associated with the surface size detector has been described in FIG. 9, redundant descriptions thereof will be omitted.

Then, the electronic apparatus 100 may identify whether an obstacle is present at the projected area (S1030). For example, the electronic apparatus 100 may identify whether an obstacle is present using the obstacle detector.

Here, the electronic apparatus 100 may identify whether an obstacle is present using the neural network model (or artificial intelligence model) and the position and size of the obstacle. Here, the neural network model may correspond to a model trained to identify an obstacle on the projection surface based on sensing data obtained by sensing the projection surface.

If the obstacle is not present at the projected area, the electronic apparatus 100 may set the current scale to the output of the obstacle detector (S1031).

Conversely, if the obstacle is present at the projected area, the electronic apparatus 100 may sense the maximum reduced scale avoiding the obstacle, and set the maximum reduced scale to the output of the obstacle detector (S1032).

For example, the electronic apparatus 100 may obtain, based on the obstacle being identified by the above-described neural network model, a maximum size area from among the area excluding the area occupied by the obstacle on the projection surface as the maximum reduced scale. Here, the maximum reduced scale may correspond to the above-described third area.

The electronic apparatus 100 may obtain, based on identifying the maximum size test image at which IR emission is not generated, the area at which the corresponding test image (reduced test image) is projected as the maximum reduced scale.

Meanwhile, the electronic apparatus 100 may identify whether there is infrared (IR) emission by the obstacle (S1040). If IR emission by the obstacle is not present, the electronic apparatus 100 may set the current scale to the output of the IR emission detector (S1041).

Conversely, if IR emission by the obstacle is present, the electronic apparatus 100 may sense the maximum reduced scale at which IR emission is not generated, and set the maximum reduced scale to the output of the IR emission detector (S1042). Because the above-described operation associated with the IR emission detector has been described in FIG. 9, redundant descriptions thereof will be omitted.

Then, the electronic apparatus 100 may identify the minimum value from among the output of the surface size detector, the output of the obstacle detector, and the output of the IR emission detector (S1050). For example, the electronic apparatus 100 may identify the minimum value from among the maximum reduced scale output by the surface size detector, the maximum reduced scale output by the obstacle detector, and the maximum reduced scale output by the IR emission detector.

Then, whether the minimum value is greater than or equal to the threshold value may be identified (S1060), and the electronic apparatus 100 may identify as failing in correction work if the minimum value is less than the threshold value (S1061). If the minimum value is greater than or equal to the threshold value, the electronic apparatus 100 may set the minimum value to the current screen scale (S1062).

Then, the electronic apparatus 100 may adjust the projection area based on the current screen scale, and project the test image or the content image at the adjusted projection area (final area). Because an operation and the like of the electronic apparatus 100 identifying the final area based on the minimum value and the threshold value have been described in detail in FIG. 9, redundant descriptions thereof will be omitted.

As described above, the electronic apparatus 100 may obtain the maximum reduced scale through not only the surface size detector 710 and the infrared emission detector 720, but also through the obstacle detector 730. The electronic apparatus 100 may obtain the minimum reduced scale corresponding to the final projection area by comparing the three maximum reduced scales.

Through the above, the electronic apparatus 100 may more accurately identify the obstacle through the neural network model for obstacle detection, and obtain a more optimized final area. That is, the electronic apparatus 100 may satisfy user needs desiring to automatically adjust the projection area to the optimal area in order to prevent touch error by using a plurality of modules that output the projectable maximum area (maximum reduced scale) through different methods, respectively.

Meanwhile, in FIG. 8 to FIG. 10, although the order of all steps has been mapped for convenience of description, but the order of steps, which have no relevance to order or which can be performed in parallel, is not necessarily limited to the relevant order.

Methods according to at least a portion from among the various embodiments of the disclosure described above may be implemented in an application form installable in an electronic apparatus of the related art.

In addition, methods according to at least a portion from among the various embodiments of the disclosure described above may be implemented with only a software upgrade or a hardware upgrade of the electronic apparatus of the related art.

In addition, methods according to at least a portion of the various embodiments of the disclosure described above may be performed through an embedded server provided in the electronic apparatus, or through at least one external server from among the electronic apparatuses.

Meanwhile, according to an embodiment of the disclosure, the various embodiments described above may be implemented with software including instructions stored in a machine-readable storage media (e.g., computer). The machine may call a stored instruction from the storage medium, and as an apparatus operable according to the called instruction, may include an electronic apparatus (e.g., electronic apparatus 100) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium. For example, the ‘non-transitory storage medium’ may include a buffer in which data is temporarily stored. According to an embodiment, a method according to the various embodiments described in the disclosure may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online (e.g., downloaded or uploaded) through an application store (e.g., PLAYSTORE™) or directly between two user devices (e.g., smartphones). In the case of online distribution, at least a portion of the computer program product (e.g., downloadable app) may be stored at least temporarily in the machine-readable storage medium such as a server of a manufacturer, a server of an application store, or a memory of a relay server, or temporarily generated.

The various embodiments of the disclosure may be implemented with software including instructions stored in the machine-readable storage media (e.g., computer). The machine may call the stored instruction from the storage medium, and as an apparatus operable according to the called instruction, may include the electronic apparatus (e.g., electronic apparatus 100) according to the above-mentioned embodiments.

When the above-described command is executed by the processor, the processor may directly or using other elements under the control of the processor perform a function corresponding to the command. The command may include a code generated by a compiler or executed by an interpreter.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a projection part configured to project images on a projection surface;
at least one sensor configured to obtain data corresponding to the projection surface, the obtained data including infrared data obtained from infrared radiation (IR) reflected from the projection surface and data not obtained from IR reflection;
a memory configured to store at least one instruction;
at least one processor configured to execute the at least one instruction in memory to:
control the projection part to project a test image on the projection surface,
obtain, based on data not obtained from IR reflection included in data corresponding to the projection surface obtained by the at least one sensor while the test image is projected on the projection surface, a first area on the projection surface,
obtain, based on infrared data included in data corresponding to the projection surface obtained by the at least one sensor, a second area on the projection surface, the second area corresponding to an area of the projection surface on which an image is projectable by the projection part, and
obtain a projection area on the projection surface based on the first area and the second area.

2. The electronic apparatus of claim 1, wherein the first area is smaller in size than an area on the projection surface on which the test image is projected and which is fully covered by the projection of the test image.

3. The electronic apparatus of claim 2, wherein the at least one processor is configured to execute the at least one instruction in memory to:
obtain an intersection image based on a plurality of images obtained from data corresponding to the projection surface,
reduce the test image to a reduced test image based on at least one intersection pixel in the obtained intersection image,
control the projection part to project the reduced test image on an area of the projection surface based on at least one intersection pixel in the obtained intersection image, and
obtain as the first area, the area on the projection surface on which the reduced test image is projected.

4. The electronic apparatus of claim 3, wherein the at least one processor is configured to execute the at least one instruction to:
obtain a first image from data corresponding to the projection surface obtained by the at least one sensor, the first image including pixel data,
obtain the intersection image based on a second image, the second image obtained based on the first image and the pixel data included in the first image,
reduce the test image to the reduced test image based on a pre-set first unit and a number corresponding to the at least one intersection pixel being greater than or equal to a first threshold number, the at least one intersection pixel having a pixel value greater than or equal to a first threshold value,
control the projection part to project the reduced test image on an area of the projection surface based on the at least one intersection pixel,
update the number corresponding to the at least one intersection pixel based on the reduced test image, and
obtain as the first area, the area on the projection surface on which the reduced test image is projected based on the updated number corresponding to the at least one intersection pixel being less than the first threshold number.

5. The electronic apparatus of claim 1, wherein the at least one processor is configured to execute the at least one instruction in memory to:
identify at least one valid pixel in an infrared image obtained from infrared data corresponding to the area on which the test image is projected, the at least one valid pixel having a pixel value greater than or equal to a second threshold value, and
obtain the second area on the projection surface based on the identified at least one valid pixel.

6. The electronic apparatus of claim 5, wherein the at least one processor is configured to execute the at least one instruction in memory to:
reduce the test image to a reduced test image based on a pre-set second unit and a number corresponding to the at least one valid pixel being greater than or equal to a second threshold number,
control the projection part to project the reduced test image on an area of the projection surface based on the at least one valid pixel,
update the number corresponding to the at least one valid pixel based on the reduced test image, and
obtain as the second area, the area on the projection surface on which the reduced test image is projected based on the updated number corresponding to the at least one valid pixel being less than the second threshold number.

7. The electronic apparatus of claim 1, wherein
the test image is a primary test image, and
the at least one processor is configured to execute the at least one instruction in memory to:
before projecting the primary test image, control the projection part to project an initial test image including an infrared pattern,
control the projection part to project the primary test image including an RGB pattern based on a function associated with a correction based on the infrared pattern not being performed, and
obtain the second area based on the infrared data included in data corresponding to the projection surface obtained while the initial test image is projected.

8. The electronic apparatus of claim 1, wherein the at least one processor is configured to execute the at least one instruction in memory to:
based on an area of a small size included in the first area and included in the second area being greater than or equal to a defined threshold size, obtain the area of a small size as the projection area.

9. The electronic apparatus of claim 1, further comprising:
a movement part,
wherein the at least one processor is configured to execute the at least one instruction in memory to:
control the movement part to move the electronic apparatus from a current position corresponding to a projection of the test image to a second position corresponding to an image projection at the projection area.

10. The electronic apparatus of claim 1, wherein the at least one processor is configured to execute the at least one instruction in memory to:
identify, using an artificial intelligence model, at least one obstacle based on data corresponding to the projection surface,
obtain a third area included in an area on the projection surface which excludes an area on the projection surface corresponding to the obstacle, and
obtain the projection area based on the first area, the second area, and the third area.

11. A method for controlling an electronic apparatus that includes a projection part configured to project images on a projection surface, and at least one sensor configured to obtain data corresponding to the projection surface, the obtained data including infrared data obtained from infrared radiation (IR) reflected from the projection surface and data not obtained from IR reflection, the method comprising:
controlling the projection part to project a test image on the projection surface;
obtaining, based on data not obtained from IR reflection included in data corresponding to the projection surface obtained by the at least one sensor while the test image is projected on the projection surface, a first area on the projection surface;
obtaining, based on infrared data included in data corresponding to the projection surface obtained by the at least one sensor, a second area on the projection surface, the second area corresponding to an area on the projection surface on which an image is projectable by the projection part; and
obtaining a projection area on the projection surface based on the first area and the second area.

12. The method of claim 11, wherein the obtaining, based on data not obtained from IR reflection included in data corresponding to the projection surface obtained by the at least one sensor while the test image is projected on the projection surface, a first area on the projection surface includes
obtaining the first area smaller in size than an area on the projection surface on which the test image is projected and which is fully covered by the test image.

13. The method of claim 12, wherein the obtaining the first area smaller in size than an area on the projection surface on which the test image is projected and which is fully covered by the test image includes:
obtaining an intersection image based on a plurality of images obtained from data corresponding to the projection surface;
reducing the test image to a reduced test image based on at least one intersection pixel in the obtained intersection image;
controlling the projection part to project the reduced test image on an area of the projection surface based on at least one intersection pixel in the obtained intersection image; and
obtaining as the first area, the area on the projection surface on which the reduced test image is projected.

14. The method of claim 13,
wherein the obtaining an intersection image based on a plurality of images obtained from data corresponding to the projection surface includes:
obtaining a first image from data corresponding to the projection surface obtained by the at least one sensor, the first image including pixel data, and
obtaining the intersection image based on a second image, the second image obtained based on the first image and the pixel data included in the first image,
wherein the reducing the test image to a reduced test image based on at least one intersection pixel in the obtained intersection image includes:
reducing the test image to a reduced test image based on a pre-set first unit and a number corresponding to the at least one intersection pixel being greater than or equal to a first threshold number, the at least one intersection pixel having a pixel value greater than or equal to a first threshold value,
wherein the obtaining as the first area, the area on the projection surface on which the reduced test image is projected includes:
updating the number corresponding to the at least one intersection pixel based on the reduced test image, and
obtaining, as the first area, the area on the projection surface on which the reduced test image is projected based on the updated number corresponding to the at least one intersection pixel being less than the first threshold number.

15. A non-transitory computer-readable storage medium which stores computer instructions for an electronic apparatus to perform an operation when executed by a processor of the electronic apparatus including a projection part configured to project images on a projection surface, and at least one sensor configured to obtain data corresponding to the projection surface, the obtained data including infrared data obtained from infrared radiation (IR) reflected from the projection surface and data not obtained from IR reflection, the operation comprising:
controlling the projection part to project a test image on the projection surface;
obtaining, based on data not obtained from IR reflection included in data corresponding to the projection surface obtained by the at least one sensor while the test image is projected on the projection surface, a first area on the projection surface;
obtaining, based on infrared data included in data corresponding to the projection surface obtained by the at least one sensor, a second area on the projection surface, the second area corresponding to an area of the projection surface on which an image is projectable by the projection part; and
obtaining a projection area on the projection surface based on the first area and the second area.
